(19) United States
(12) Patent Application Publication
(10) Pub. No.: US 2026/0255131 A1
(43) Pub. Date: Aug. 27, 2026

(54) SURVEILLANCE APPARATUS, SURVEILLANCE METHOD, AND STORAGE MEDIUM

(71) Applicant: NEC Corporation, Minato-ku, Tokyo (JP)

(72) Inventor: Masumi Ishikawa, Tokyo (JP)

(73) Assignee: NEC Corporation, Minato-ku, Tokyo (JP)

(21) Appl. No.: 18/729,598

(22) PCT Filed: Jan. 28, 2022
(86) PCT No.: PCT/JP2022/003433

§ 371 Date: Jul. 17, 2024

(51) Int. Cl. H04W 4/029; G08B 13/196

(52) U.S. Cl. CPC H04W 4/029; G08B 13/196

(57) ABSTRACT

A surveillance apparatus (101) includes a first acquisition unit (104), a second acquisition unit (105), and a correlation unit (106). The first acquisition unit (104) acquires first moving body information MD1 including the position of a held apparatus (107) held by a predetermined moving body MB. The second acquisition unit (105) acquires second moving body information MD2 including the position and the type of a sensor moving body SMB being a moving body MB detected based on sensor information SI generated by a sensor apparatus (103). The correlation unit (106) correlates the first moving body information MD1 and the second moving body information MD2 that are related to a common moving body MB, based on the position of the held apparatus (107), and the position and the type of the sensor moving body SMB.

### TECHNICAL FIELD

The present invention relates to a surveillance apparatus, a surveillance method, and a program.

### BACKGROUND ART

Patent Document 1 and Patent Document 2 describe examples of a system for surveilling a moving body.

A position determination system described in Patent Document 1 includes: a wireless terminal apparatus held by a surveillance target as a moving body; and a sensor apparatus including a wireless communication unit that wirelessly communicates with the wireless terminal apparatus, and a camera unit that captures an image of the surveillance target.

The sensor apparatus described in Patent Document 1 detects the position of a wireless terminal apparatus (a tag position), based on a detection signal from the wireless terminal apparatus, and also computes the position of a surveillance target, based on an image captured by the camera unit. The position determination system described in Patent Document 1 determines the position of the surveillance target by tying the tag position to the image position.

A position detection system described in Patent Document 2 includes a first positioning unit, a second positioning unit, and a determination unit.

The first positioning unit described in Patent Document 2 includes a plurality of transmitters that transmit electromagnetic waves and a receiver that receives the electromagnetic waves transmitted by the plurality of transmitters. The first positioning unit acquires first positioning data related to the positions of the plurality of transmitters existing in a target area, based on an electromagnetic wave received from each of the plurality of transmitters by the receiver.

The second positioning unit described in Patent Document 2 acquires second positioning data related to the position of a predetermined moving body (an authenticated person) existing in the target area and the position of a target moving body (a suspicious person), by at least one of a pressure sensor, a camera, an infrared sensor, and a sound wave.

The determination unit described in Patent Document 2 determines the position of the target moving body in the target area by comparing the first positioning data with the second positioning data. Patent Document 2 describes that by comparing the positions of the plurality of transmitters with the positions of the predetermined moving body and a target moving body, the determination unit determines the positions of the predetermined moving body and a target moving body that are positioned at locations not overlapping with the positions of the transmitters.

### RELATED DOCUMENT

### Patent Document

Patent Document 1: International Application Publication No. WO 2009/113265

Patent Document 2: Japanese Patent Application Publication No. 2006-311111

### DISCLOSURE OF THE INVENTION

### Technical Problem

However, in Patent Document 1, each position of a surveillance target computed based on a tag position and an image may generally have an error. Therefore, in the position determination system described in Patent Document 1, a tag position may not be correctly tied to an image position, and as a result, a moving body as a surveillance target may not be precisely detected.

Similarly in Patent Document 2, each of the positions of the plurality of transmitters, and the positions of the predetermined moving body and a target moving body may generally have an error. Therefore, whether the positions of the transmitter overlap with the positions of the predetermined moving body and the target moving body may be erroneously determined, and as a result, the moving bodies may not be precisely detected.

An example of an object of the present invention is to, in view of the issue described above, provide a surveillance apparatus, a surveillance method, and a program that resolve the issue that a moving body may not be precisely detected.

### Solution to Problem

An embodiment of the present invention provides a surveillance apparatus including:
a first acquisition unit that acquires first moving body information including a position of a held apparatus held by a predetermined moving body;
a second acquisition unit that acquires second moving body information including a position and a type of a sensor moving body being a moving body detected based on sensor information generated by a sensor apparatus; and
a correlation unit that correlates the first moving body information and the second moving body information that are related to a common moving body, based on a position of the held apparatus, and a position and a type of the sensor moving body.

An embodiment of the present invention provides a surveillance method including, by a computer:
acquiring first moving body information including a position of a held apparatus held by a predetermined moving body;
acquiring second moving body information including a position and a type of a sensor moving body being a moving body detected based on sensor
information generated by a sensor apparatus; and correlating the first moving body information and the second moving body information that are related to a common moving body, based on a position of the held apparatus, and a position and a type of the sensor moving body.

An embodiment of the present invention provides a program for causing a computer to execute:
acquiring first moving body information including a position of a held apparatus held by a predetermined moving body;
acquiring second moving body information including a position and a type of a sensor moving body being a moving body detected based on sensor information generated by a sensor apparatus; and
correlating the first moving body information and the second moving body information that are related to a common moving body, based on a position of the held apparatus, and a position and a type of the sensor moving body.

### Advantageous Effects of Invention

The present invention enables precise detection of a moving body.

### BRIEF DESCRIPTION OF THE DRAWINGS

FIG. 1 is a diagram illustrating an overview of a surveillance system according to a first example embodiment of the present invention.

FIG. 2 is a flowchart illustrating an example of surveillance processing according to the first example embodiment of the present invention.

FIG. 3 is a plan view illustrating an example of status of a surveillance area MA at a time T1.

FIG. 4 is a diagram illustrating a detailed configuration example of a positioning system according to the first example embodiment.

FIG. 5 is a diagram illustrating a physical configuration example of a surveillance apparatus according to the first example embodiment of the present invention.

FIG. 6 is a diagram illustrating a physical configuration example of a sensor apparatus according to the first example embodiment of the present invention.

FIG. 7 is a diagram illustrating a physical configuration example of a held apparatus according to the first example embodiment of the present invention.

FIG. 8 is a diagram illustrating a physical configuration example of a communication apparatus according to the first example embodiment of the present invention.

FIG. 9 is a diagram illustrating an example of a flow of positioning processing according to the first example embodiment of the present invention.

FIG. 10 is a diagram illustrating an example of first moving body information.

FIG. 11 is a flowchart illustrating an example of sensing processing according to the first example embodiment of the present invention.

FIG. 12 is a diagram illustrating an example of sensor information.

FIG. 13 is a flowchart illustrating an example of preparation processing according to the first example embodiment of the present invention.

FIG. 14 is a flowchart illustrating an example of second acquisition processing according to the first example embodiment of the present invention.

FIG. 15 is a diagram illustrating an example of second moving body information.

FIG. 16 is a flowchart illustrating an example of correlation processing according to the first example embodiment of the present invention.

FIG. 17 is a diagram illustrating an example of standard velocity data.

FIG. 18 is a diagram illustrating a first example of correlation information.

FIG. 19 is a diagram illustrating an example of detection result information.

FIG. 20 is a diagram illustrating an example of a configuration of a positioning system according to a modified example 1.

FIG. 21 is a diagram illustrating an example of apparatus information.

FIG. 22 is a flowchart illustrating an example of correlation processing according to a modified example 2.

FIG. 23 is a diagram for illustrating an example of a method for correcting a position.

FIG. 24 is a diagram illustrating an overview of a surveillance system according to a second example embodiment of the present invention.

FIG. 25 is a flowchart illustrating an example of surveillance processing according to the second example embodiment of the present invention.

FIG. 26 is a diagram illustrating an example of a mapping diagram.

FIG. 27 is a diagram illustrating an overview of a surveillance system according to a third example embodiment of the present invention.

FIG. 28 is a flowchart illustrating an example of surveillance processing according to the third example embodiment of the present invention.

FIG. 29 is a flowchart illustrating an example of notification processing according to the third example embodiment of the present invention.

### EXAMPLE EMBODIMENT

Example embodiments of the present invention will be described below by using drawings. Note that in every drawing, similar components are given similar signs, and description thereof is omitted as appropriate.

### First Example Embodiment

### Overview of First Example Embodiment

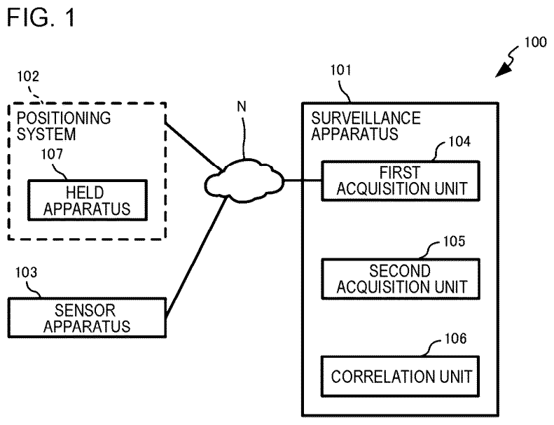

FIG. 1 is a diagram illustrating an overview of a surveillance system 100 according to a first example embodiment of the present invention. The surveillance system 100 is a system for surveilling a surveillance area MA. The surveillance system 100 includes a surveillance apparatus 101, and a positioning system 102 and a sensor apparatus 103 that mutually communicate with the surveillance apparatus 101 through a network N. The network N is a wired network, a wireless network, or a communication network configured with a combination of the two.

The surveillance apparatus 101 includes a first acquisition unit 104, a second acquisition unit 105, and a correlation unit 106.

The first acquisition unit 104 acquires first moving body information MD1 including the position of a held apparatus 107 held by a predetermined moving body MB.

The second acquisition unit 105 acquires second moving body information MD2 including the position and the type of a sensor moving body SMB being a moving body MB detected based on sensor information SI generated by the sensor apparatus 103.

The correlation unit 106 correlates the first moving body information MD1 and the second moving body information MD2 that are related to a common moving body MB, based on the position of a held apparatus 107, and the position and the type of a sensor moving body SMB.

The positioning system 102 includes a held apparatus 107 and generates the first moving body information MD1 including the position of the held apparatus 107. The sensor apparatus 103 generates sensor information SI.

The surveillance system 100 enables precise determination of a moving body MB. Further, the surveillance apparatus 101 according to the first example embodiment enables precise determination of a moving body MB.

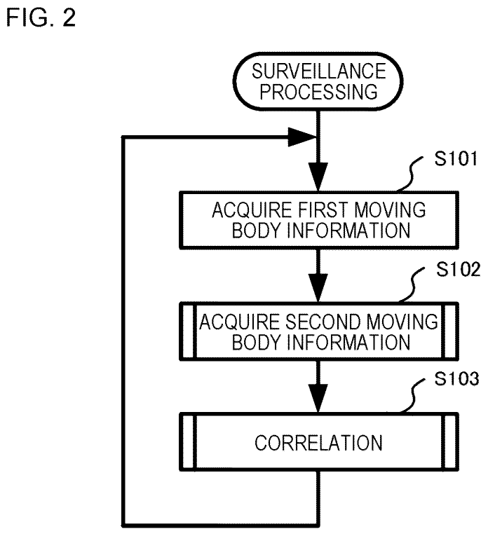

FIG. 2 is a flowchart illustrating an example of surveillance processing according to the present example embodiment. The surveillance processing is processing executed by the surveillance apparatus 101 for surveilling the surveillance area MA. For example, the surveillance apparatus 101 starts the surveillance processing in response to a start instruction from a user. The surveillance apparatus 101 ends the surveillance processing in response to an end instruction to the surveillance apparatus 101 from the user.

The first acquisition unit 104 acquires first moving body information MD1 including the position of a held apparatus 107 held by a moving body MB (Step S101).

The second acquisition unit 105 acquires second moving body information including the position and the type of a sensor moving body SMB being a moving body detected based on sensor information SI generated by the sensor apparatus 103 (Step S102).

The correlation unit 106 correlates first moving body information MD1 and second moving body information MD2 that are related to a common moving body MB, based on the position of a held apparatus 107, and the position and the type of a sensor moving body SMB (Step S103).

The surveillance processing enables precise determination of a moving body.

Details of the first example embodiment of the present invention will be described below with a case of the positioning system 102 including a plurality of held apparatuses 107a to 107d as an example. “Held apparatuses 107” is a general name for the held apparatuses 107a to 107d when the held apparatuses 107a to 107d are not particularly distinguished from each other.

Note that as may be understood from the description of the overview of the first example embodiment, the surveillance system 100 has only to include at least one sensor apparatus 103. Further, the positioning system 102 has only to include at least one held apparatus 107.

### Details of First Example Embodiment

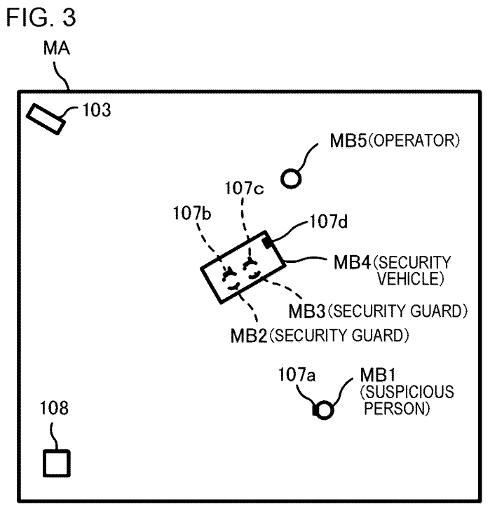

FIG. 3 is a plan view illustrating an example of status of the surveillance area MA at a time T1. The time Tl is a certain time during operation of the surveillance system 100.

The surveillance area MA is an area set as a surveillance target in various facilities, buildings, or the like. The surveillance area MA may be either of indoors or outdoors. An off-limits area where entry of other than a predetermined moving body MB is prohibited or an area set on the outer periphery thereof in an important facility such as an airport, a power plant, a harbor, or a defense facility is suitable as the surveillance area MA.

A moving body MB is a person or a movable object. Examples of an object as a moving body MB include an automobile, an animal, a motorcycle, a bicycle, a drone, and a self-propelled robot. Note that moving bodies MB also include a person or an object at a standstill.

Moving bodies MB1 to MB5 exist in the surveillance area MA in the exampkle illustrated in FIG. 3.

The moving bodies MB1 to MB4 are examples of a moving body MB predetermined as a moving body MB entry of which into the surveillance area MA is permitted. The moving bodies MB1 to MB4 entry of which into the surveillance area MA is permitted hold held apparatuses 107a to 107d as illustrated in the diagram, respectively.

Specifically, the moving body MB1 is an operator carrying the held apparatus 107a.

The moving bodies B2 and MB3 are security guards on board the moving body MB4 (a security vehicle). The moving body MB2 carries the held apparatus 107b. The moving body MB3 carries the held apparatus 107c.

The moving body MB4 is a security vehicle (that is, an automobile for security) equipped with the held apparatus 107d.

The moving body MB5 is a suspicious moving body MB (a person in the example in the diagram) not holding a held apparatus 107.

“Moving bodies MB” is a general name for the moving bodies MB1 to MB5 when the moving bodies MB1 to MB5 are not particularly distinguished from each other.

Note that there may be a plurality of surveillance areas MA surveilled by the surveillance system 100.

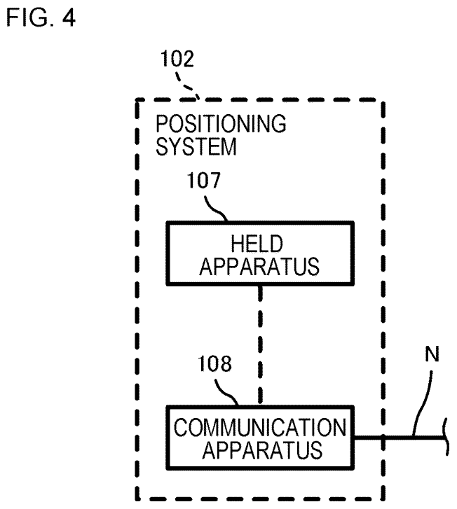

FIG. 4 is a diagram illustrating a detailed configuration example of the positioning system 102 according to the present example embodiment. The positioning system 102 is a system for measuring the position of a moving body MB holding a held apparatus 107.

The positioning system 102 includes a held apparatus 107 and a communication apparatus 108. The held apparatus 107 and the communication apparatus 108 wirelessly communicate with each other. The wireless communication is communication using an electromagnetic wave EW.

A held apparatus 107 transmits an electromagnetic wave EW used for positioning of the held apparatus 107. An electromagnetic wave EW used for positioning of a held apparatus 107 may include various types of information.

For example, an electromagnetic wave EW includes an apparatus identifier (ID) of a held apparatus 107 transmitting the electromagnetic wave EW. An apparatus ID is information for identifying a held apparatus 107.

The communication apparatus 108 receives an electromagnetic wave EW used for positioning of a held apparatus 107 from the held apparatus 107. The communication apparatus 108 acquires the position of a held apparatus 107, based on an electromagnetic wave EW used for positioning of the held apparatus 107. The communication apparatus 108 generates first moving body information MD1 including the position of a held apparatus 107. The communication apparatus 108 transmits the first moving body information MD1 to the surveillance apparatus 101.

For example, the communication apparatus 108 is installed in the surveillance area MA or within a predetermined range from the surveillance area MA in such a way as to be able to receive an electromagnetic wave EW from a held apparatus 107 existing in the surveillance area MA.

Note that the positioning system 102 may include a plurality of communication apparatuses 108.

FIG. 1 is referred to again.

The sensor apparatus 103 captures an image of a predetermined image capture region. The sensor apparatus 103 generates image data PD. The image data PD according to the present example embodiment are image data indicating an image of the image capture region.

The image capture region according to the present example embodiment is the surveillance area MA (see FIG. 3). Therefore, for example, the sensor apparatus 103 is installed in the surveillance area MA or within a predetermined range from the surveillance area MA in such a way as to be able to capture an image of the surveillance area MA. Note that the surveillance system 100 may include a plurality of sensor apparatuses 103.

The sensor apparatus 103 generates sensor information SI including the image data PD. The sensor apparatus 103 transmits the sensor information SI to the surveillance apparatus 101.

### Details of Functional Configuration of Surveillance Apparatus 101

Details of the functional configuration of the surveillance apparatus 101 according to the first example embodiment will be described with reference to FIG. 1.

The first acquisition unit 104 continuously acquires first moving body information MD1 from the communication apparatus 108 through the network N.

The second acquisition unit 105 continuously acquires sensor information SI from the communication apparatus 108 through the network N.

By processing image data PD included in the sensor information SI, the second acquisition unit 105 detects a sensor moving body SMB being a moving body MB included in the image data PD and acquires the position and the type of the detected sensor moving body SMB. Examples of the type of a moving body MB include a person, an animal, an automobile, a motorcycle, a bicycle, a drone, and a self-propelled robot.

The second acquisition unit 105 acquires second moving body information MD2 including the position and the type of the sensor moving body SMB.

The correlation unit 106 acquires the moving velocity of a held apparatus 107 based on a position included in the first moving body information MD1 acquired by the first acquisition unit 104. The correlation unit 106 correlates first moving body information MD1 and second moving body information MD2 that are related to a common moving body MB, based on the position and the moving velocity of a held apparatus 107, and the position and the type of a sensor moving body SMB.

### Physical Configuration of Surveillance System 100

Each of the surveillance apparatus 101, the sensor apparatus 103, the held apparatus 107, and the communication apparatus 108 that are included in the surveillance system 100 is configured with a physically different single apparatus.

Note that the whole or part of the surveillance apparatus 101, the sensor apparatus 103, the held apparatus 107, and the communication apparatus 108 may be physically configured with a plurality of apparatuses.

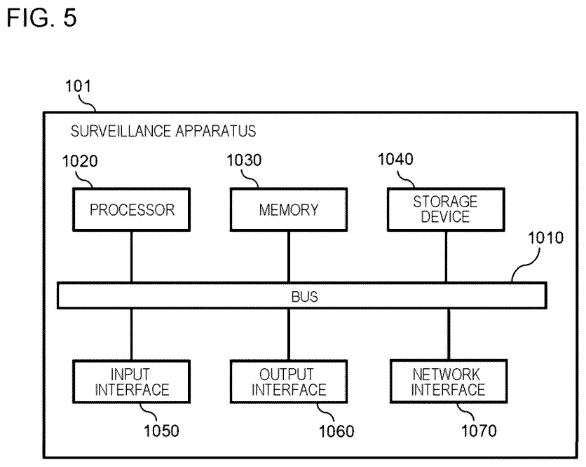

For example, the surveillance apparatus 101 is physically a tablet personal computer (PC), a smartphone, or the like. As illustrated in a physical configuration example in FIG. 5, the surveillance apparatus 101 includes a bus 1010, a processor 1020, a memory 1030, a storage device 1040, an input interface 1050, an output interface 1060, and a network interface 1070.

The bus 1010 is a data transmission channel for the processor 1020, the memory 1030, the storage device 1040, the input interface 1050, the output interface 1060, and the network interface 1070 to transmit and receive data to and from each other. Note that the method for interconnecting the processor 1020 and other components is not limited to a bus connection.

The processor 1020 is a processor provided by a central processing unit (CPU), a graphics processing unit (GPU), or the like.

The memory 1030 is a main storage provided by a random-access memory (RAM) or the like.

The storage device 1040 is an auxiliary storage provided by a hard disk drive (HDD), a solid-state drive (SSD), a memory card, a read-only memory (ROM), or the like. The storage device 1040 stores program modules for providing the functions of the surveillance apparatus 101. By reading each program module into the memory 1030 and executing the program module by the processor 1020, each function related to the program module is provided.

The input interface 1050 is an interface for a user to input information, examples of the interface including a touch panel, a keyboard, and a mouse.

The output interface 1060 is an interface for providing information to a user, examples of the interface including a liquid crystal panel and an organic electroluminescence (EL) panel.

The network interface 1070 is an interface for connecting the surveillance apparatus 101 to the network N.

### Physical Configuration of Sensor Apparatus 103

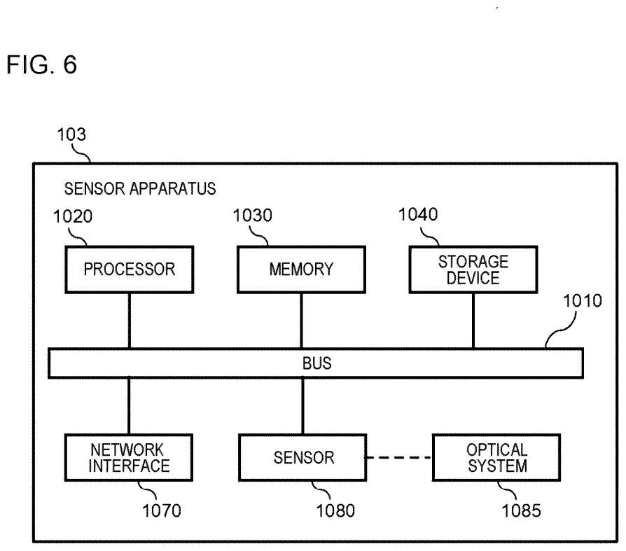

For example, the sensor apparatus 103 is physically a camera generating two-dimensional image data PD or a stereo camera generating three-dimensional image data PD. As illustrated in a physical configuration example in FIG. 6, the sensor apparatus 103 includes a bus 1010, a processor 1020, a memory 1030, a storage device 1040, and a network interface 1070 that are similar to those in the surveillance apparatus 101. The sensor apparatus 103 further includes a sensor 1080 and an optical system 1085.

The sensor 1080 is an image sensor converting an image into an electric signal. The optical system 1085 is a lens or the like used with the sensor 1080.

Note that the sensor apparatus 103 is physically not limited to a camera and, for example, may be a ranging apparatus measuring the distance to a target by using light, a radio wave (a millimeter wave), an ultrasonic wave, or the like. Examples of a ranging technology using light include light detection and ranging (LIDAR). Examples of a ranging technology using a radio wave include radio detecting and ranging (RADER).

In this case, the sensor apparatus 103 may not include the optical system 1085. Further, the sensor 1080 in this case is an optical sensor, a radio wave sensor, an ultrasonic sensor, or the like. For example, an optical sensor is a sensor emitting light and detecting the reflected light from a target. For example, a radio wave sensor is a sensor emitting a radio wave and detecting the radio wave reflected off a target. For example, an ultrasonic sensor is a sensor emitting an ultrasonic wave and detecting the ultrasonic wave reflected off a target. In this case, the sensor apparatus 103 generates point cloud data including point cloud information in place of image data PD including an image.

Further, data including an image suited for detecting a sensor moving body SMB are preferably selected as image data PD. Therefore, image data PD may include a visible image, a near-infrared image indicating a near-infrared reflectance characteristic, a thermographic image visualizing a temperature characteristic, or the like. In such a case, the sensor apparatus 103 may be a camera that can acquire a visible image (a visible light camera), an infrared camera, a thermographic camera, or the like.

### Physical Configuration of Held Apparatus 107 and Communication Apparatus 108

The positioning system 102 configured with the held apparatus 107 and the communication apparatus 108 is a system provided by using various positioning technologies such as a real time location system (RTLS).

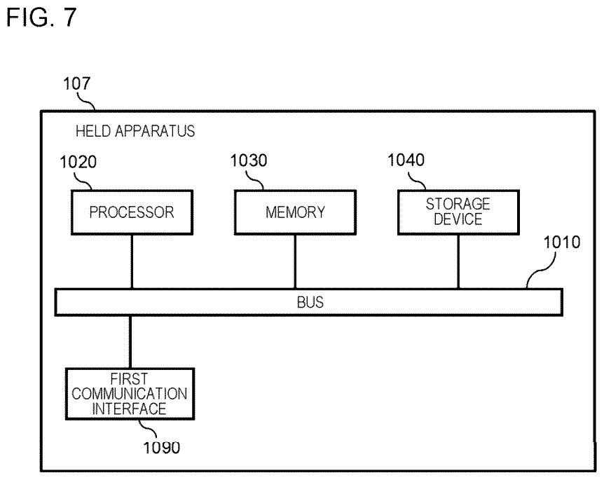

For example, the held apparatus 107 is physically a tag or a smartphone. As illustrated in a physical configuration example in FIG. 7, the held apparatus 107 includes a bus 1010, a processor 1020, a memory 1030, and a storage device 1040 that are similar to those in the surveillance apparatus 101. The held apparatus 107 further includes a first communication interface 1090.

The first communication interface 1090 is an interface for communication with the communication apparatus 108. For example, the first communication interface 1090 is a communication interface conforming to a standard or a technology, such as Bluetooth Low Energy (BLE) or ultra-wideband (UWB).

Further, for example, the first communication interface 1090 is a communication interface conforming to a radio-frequency identification (RFID) technology.

Furthermore, for example, the first communication interface 1090 is a communication interface conforming to a wireless local area network (LAN) standard (such as Wi-Fi).

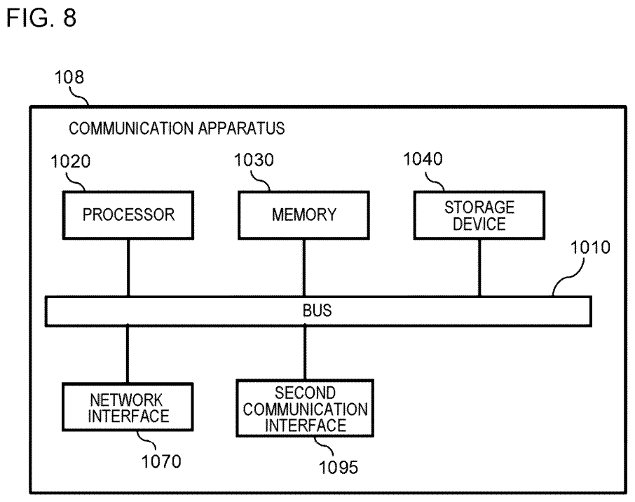

As illustrated in a physical configuration example in FIG. 8, the communication apparatus 108 includes a bus 1010, a processor 1020, a memory 1030, a storage device 1040, and a network interface 1070 that are similar to those in the surveillance apparatus 101. The communication apparatus 108 further includes a second communication interface 1095.

The second communication interface 1095 is an interface for communication with the held apparatus 107. The second communication interface 1095 is a communication interface conforming to a standard or a technology similar to that employed by the first communication interface 1090.

Note that each of the sensor apparatus 103, the held apparatus 107, the communication apparatus 108 may include one or both of an input interface 1050 and an output interface 1060 that are similar to those in the surveillance apparatus 101. Further, the sensor apparatus 103 may be configured with a camera and a ranging apparatus.

### Operation of Surveillance System 100

The operation of the surveillance system 100 will be described with reference to a diagram.

The surveillance system 100 executes surveillance system processing. The surveillance system processing is processing for surveilling the surveillance area MA. The surveillance system processing includes positioning processing, sensing processing, and the aforementioned surveillance processing.

### Positioning Processing According to First Example Embodiment

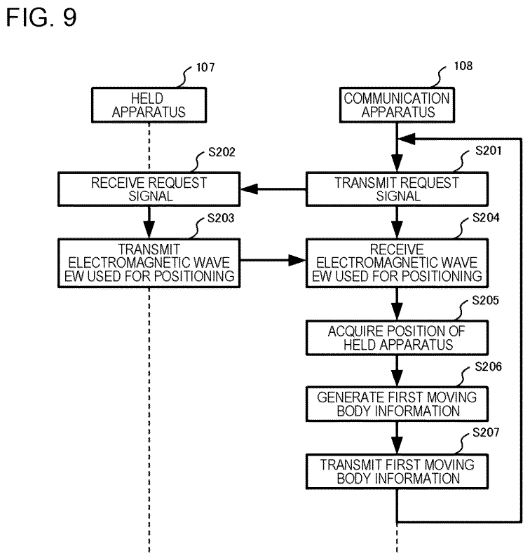

FIG. 9 is a diagram illustrating an example of a flow of the positioning processing according to the first example embodiment of the present invention. The positioning processing is processing executed by the positioning system 102 for surveilling the surveillance area MA.

For example, the positioning system 102 starts the positioning processing when acquiring, through the network N, a start signal from the surveillance apparatus 101 receiving a start instruction from a user. For example, the positioning system 102 ends the positioning processing when acquiring, through the network N, an end signal from the surveillance apparatus 101 receiving an end instruction from the user.

The communication apparatus 108 transmits a request signal (Step S201). The request signal is a signal for requesting transmission of an electromagnetic wave EW used for positioning of a held apparatus 107. In Step S201, the communication apparatus 108 transmits a request signal to the entire surveillance area MA.

A held apparatus 107 receives the request signal transmitted in Step S201 (Step S202). In Step S202, each of the held apparatuses 107a to 107d existing in the surveillance area MA receives the request signal.

A held apparatus 107 transmits an electromagnetic wave EW used for positioning of the held apparatus 107 (Step S203). In Step S203, each of the held apparatuses 107a to 107d receiving the request signal transmits an electromagnetic wave EW used for positioning. An electromagnetic wave EW used for positioning includes the apparatus ID of a held apparatus 107 transmitting the electromagnetic wave EW.

The communication apparatus 108 receives an electromagnetic wave EW transmitted in Step S203 (Step S204). In Step S204, the communication apparatus 108 receives an electromagnetic wave EW used for positioning from each of the held apparatuses 107a to 107d.

The communication apparatus 108 acquires the position of a held apparatus 107, based on the reception intensity, the direction, and the like of the electromagnetic wave EW received in Step S204 (Step S205).

For example, the communication apparatus 108 acquires the position of the held apparatus 107a, based on the reception intensity, the direction, and the like of an electromagnetic wave EW used for positioning received from the held apparatus 107a. The communication apparatus 108 performs similar processing on each of the held apparatuses 107b to d. Thus, the communication apparatus 108 acquires the position of each of the held apparatuses 107a to 107d in Step S205.

The communication apparatus 108 generates first moving body information MD1 including the positions acquired in Step S205 (Step S206).

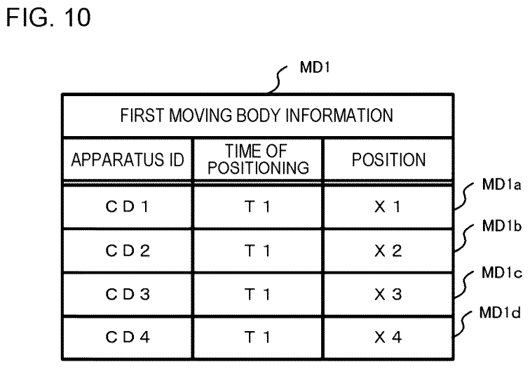

More specifically, the communication apparatus 108 generates first moving body information MD1 as illustrated in FIG. 10 in Step S206.

FIG. 10 is a diagram illustrating an example of first moving body information MD1. First moving body information MD1 is information in which an apparatus ID, a time of positioning, and a position are associated with each other. In first moving body information MD1, an apparatus ID, a time of positioning, and a position are associated with each other for each electromagnetic wave EW used for positioning.

The first moving body information MD1 illustrated in the diagram includes pieces of first moving body information MDla to MD1d for the held apparatuses 107a to 107d, respectively.

For example, an apparatus ID “CD1,” a time of positioning “T1,” and a position “X1” are associated with each other in the first moving body information MDla for the held apparatus 107a.

The apparatus ID “CD1” is the apparatus ID of the held apparatus 107a. The apparatus ID “CD1” is included in the electromagnetic wave EW received from the held apparatus 107a in Step S204.

The time of positioning “T1” is the time when positioning of the held apparatus 107a is performed. For example, the time of positioning is the time when the electromagnetic wave EW is received from the held apparatus 107a in Step S204. Note that when the electromagnetic wave EW transmitted by the held apparatus 107a in Step S203 includes a time of transmission, the time of positioning may be the time of transmission. Further, the time of positioning may be the time when a request signal is transmitted in Step S201.

The position “X1” indicates the position of the held apparatus 107a at the time T1. The position “X1” is a position acquired in Step S205, based on the electromagnetic wave EW received from the held apparatus 107a in Step S204.

For example, a position is represented by a three-dimensional coordinate system correlated with a real space or a two-dimensional coordinate system correlated with a plane acquired by viewing a real space from above.

FIG. 9 is referred to again.

The communication apparatus 108 transmits the first moving body information MD1 generated in Step S206 to the surveillance apparatus 101 through the network N (Step S207).

The communication apparatus 108 executes Step S201 again. In other words, the positioning system 102 repeatedly executes Steps S201 to S207. As a result, the positioning system 102 can continuously transmit first moving body information MD1 in real time.

At this time, the communication apparatus 108 may execute Step S201 again after a predetermined time elapses since execution of Step S207. Thus, the communication apparatus 108 can continuously transmit real-time first moving body information MD1 at predetermined time intervals.

An example of a held apparatus 107 receiving a request signal from the communication apparatus 108 and transmitting an electromagnetic wave EW used for positioning has been described. However, a held apparatus 107 and the communication apparatus 108 may not execute transmission and reception of a request signal (Step S201 and S202). In this case, for example, a held apparatus 107 may transmit an electromagnetic wave EW used for positioning at predetermined time intervals.

### Sensing Processing According to First Example Embodiment

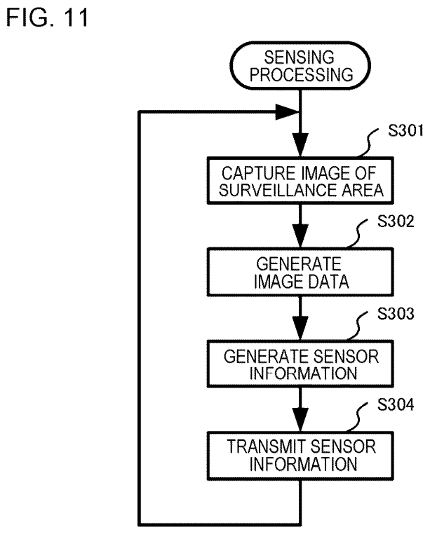

FIG. 11 is a flowchart illustrating an example of the sensing processing according to the first example embodiment of the present invention. The sensing processing is processing executed by the sensor apparatus 103 for surveilling the surveillance area MA.

For example, the sensor apparatus 103 starts the sensing processing when acquiring, through the network N, a start signal from the surveillance apparatus 101 receiving a start instruction from a user. For example, the sensor apparatus 103 ends the sensing processing when acquiring, through the network N, an end signal from the surveillance apparatus 101 receiving an end instruction from the user.

The sensor apparatus 103 captures an image of the surveillance area MA (Step S301).

The sensor apparatus 103 generates image data PD indicating the image of the surveillance area MA captured in Step S101 (Step S302).

The sensor apparatus 103 generates sensor information SI including the image data PD generated in Step S302 (Step S303).

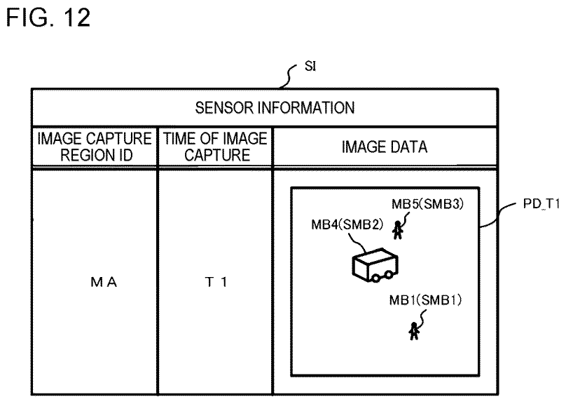

More specifically, the sensor apparatus 103 generates sensor information SI as illustrated in FIG. 12 in Step S303.

FIG. 12 is a diagram illustrating an example of sensor information SI. As illustrated in the diagram, sensor information SI is information in which an image capture region ID, a time of image capture, and image data are associated with each other. For each execution of image capture processing (Step S301), an image capture region ID, a time of image capture, and image data that are related to the image capture processing (Step S301) are associated with each other in sensor information SI.

An image capture region ID is information for identifying an image capture region of the sensor apparatus 103. An image capture region ID “MA” is an image capture region ID of the surveillance area MA being an image capture region of the sensor apparatus 103. The sensor apparatus 103 holds the preset image capture region ID “MA.”

A time of image capture is information indicating the time when image capture is performed. A time of image capture “T1” indicates the time when the image capture in Step S301 is performed.

Image data are data indicating an image generated in Step S302, based on the image capture in Step S301. Image data in sensor information SI indicate an image of an image capture region identified by an image capture region ID associated with the image data PD captured at a time of image capture associated with the image data PD.

The sensor information SI illustrated in the diagram includes image data PD_Tl as image data. In the sensor information SI, the image data PD_T1 are associated with the image capture region ID “MA” and the time of image capture “T1.” In other words, the image data PD_T1 indicate an image of the image capture region MA captured at the time T1.

The image data PD_T1 include the moving bodies MB1, MB4, and MB5. The moving bodies B2 and MB3 are on board the moving body MB4 (a security vehicle) and therefore are not included in the image of the image data PD_T1 or are not included in such a way as to be detectable from the image.

FIG. 11 is referred to again.

The sensor apparatus 103 transmits the sensor information SI generated in Step S303 to the surveillance apparatus 101 through the network N (Step S304).

The sensor apparatus 103 executes Step S301 again. In other words, the sensor apparatus 103 repeatedly executes Steps S301 to S304. As a result, the sensor apparatus 103 can continuously transmit sensor information SI in real time.

At this time, the sensor apparatus 103 may execute Step S301 again after a predetermined time elapses since execution of Step S304. Thus, the communication apparatus 108 can continuously transmit real-time sensor information SI at predetermined time intervals.

### Details of Surveillance Processing According to First Example Embodiment

As described above, the surveillance apparatus 101 starts the surveillance processing in response to a start instruction from a user. More specifically, the surveillance apparatus 101 accepts a start instruction during operation.

Subsequently, the surveillance apparatus 101 executes preparation processing in accordance with the start instruction and then starts the surveillance processing.

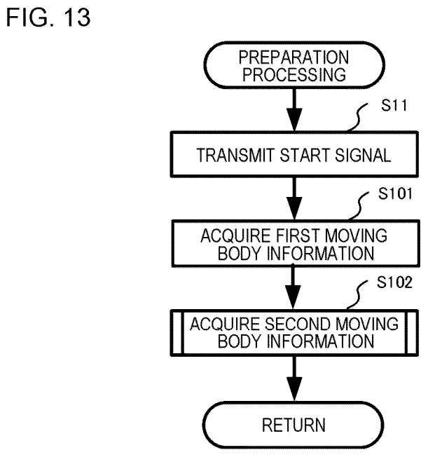

FIG. 13 is a flowchart illustrating an example of the preparation processing according to the present example embodiment.

The surveillance apparatus 101 transmits a predetermined start signal to each of the sensor apparatus 103 and the communication apparatus 108 (Step S11). The first acquisition unit 104 executes first acquisition processing (Step S101). The second acquisition unit 105 executes second acquisition processing (Step S102). The surveillance apparatus 101 ends the preparation processing.

FIG. 2 is referred to again.

The first acquisition unit 104 acquires, through the network N, first moving body information MD1 transmitted in Step S207 (Step S101). The first acquisition unit 104 holds the acquired first moving body information MD1. As described with reference to FIG. 10, the first moving body information MD1 transmitted in Step S207 is first moving body information MD1 generated in Step S206.

The second acquisition unit 105 acquires second moving body information including the position and the type of a sensor moving body SMB detected based on sensor information SI generated in Step S303 (Step S102).

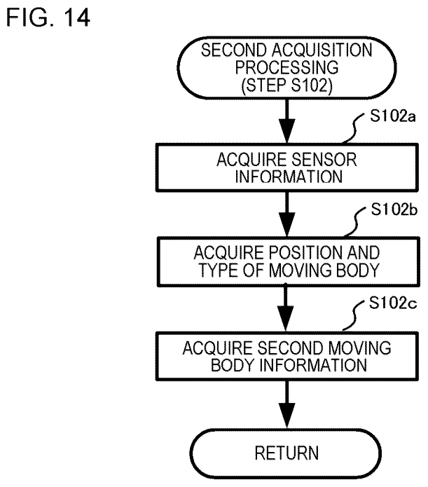

FIG. 14 is a flowchart illustrating an example of the second acquisition processing according to the present example embodiment (Step S102).

The second acquisition unit 105 acquires, through the network N, sensor information SI transmitted in Step S304 (Step S102a).

The second acquisition unit 105 holds the acquired sensor information SI. As described with reference to FIG. 11, the sensor information SI transmitted in The second acquisition unit 105 acquires the position and the type of a sensor moving body SMB by processing image data PD included in the sensor information SI acquired in Step S102a (Step S102b).

For example, the processing performed on the image data PD in Step S102b is generally known image processing using image mapping, a learning model trained by machine learning, or the like.

When a learning model is used, the second acquisition unit 105 inputs image data PD to a learning model trained by machine learning for acquiring the position and the type of a moving body MB and acquires the position and the type of a moving body MB included in the image data PD.

For example, input data to the learning model during learning are image data PD. For example, the machine learning is supervised learning with the position and the type of a moving body MB included in the image data PD as a correct answer.

For example, as described above, the image data PD_T1 included in the sensor information SI illustrated in FIG. 12 include the moving bodies MB1, MB4, and MB5 as detectable moving bodies MB. For example, as a result of execution of Step S102b, the second acquisition unit 105 detects sensor moving bodies SMB1, SMB2, and SMB3, based on images of the moving bodies MB1, MB4, and MB5, respectively. Then, the second acquisition unit 105 acquires the position and the type of each of the sensor moving bodies SMB1 to SMB3.

A position is represented by a coordinate system similar to that for a position included in first moving body information MD1.

“Sensor moving bodies SMB” is a general name for the SMB1 to SMB3 when the SMB1 to SMB3 are not particularly distinguished from each other.

For example, the second acquisition unit 105 acquires a position “Y1” and a type “person” for the sensor moving body SMB1. The second acquisition unit 105 acquires a position “Y2” and a type “automobile” for the sensor moving body SMB2. The second acquisition unit 105 acquires a position “Y3” and a type “person” for the sensor moving body SMB3.

The second acquisition unit 105 acquires second moving body information MD2 including the position and the type of the moving body MB acquired in Step S102b (Step S102c).

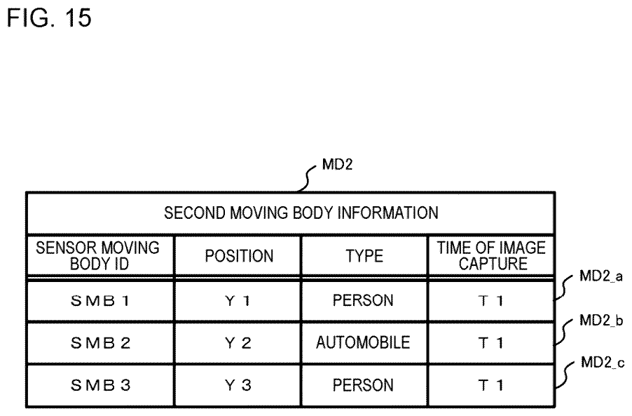

More specifically, the second acquisition unit 105 acquires second moving body information MD2 as illustrated in FIG. 15 in Step S102c.

FIG. 15 is a diagram illustrating an example of second moving body information MD2. As illustrated in the diagram, second moving body information MD2 is information in which a sensor moving body ID, a position, a type, and a time of image capture are associated with each other. For each sensor moving body SMB detected based on sensor information SI, a sensor moving body ID, a position, a type, and a time of image capture are associated with each other in second moving body information MD2.

The second moving body information MD2 illustrated in the diagram includes pieces of second moving body information MD2a to MD2c for the sensor moving bodies SMB1 to SMB3, respectively.

For example, a sensor moving body ID “SMB1,” a position “Y1,” a type “person,” and a time of image capture “T1” are associated with each other in the second moving body information MD2a for the sensor moving body SMB1.

The sensor moving body ID “SMB1” is information for identifying the sensor moving body SMB1. When detecting a sensor moving body SMB in Step S102b, the second acquisition unit 105 assigns a sensor moving body ID to the detected sensor moving body SMB as appropriate, for example, in accordance with a predetermined rule. The sensor moving body ID “SMB1” is information assigned to the sensor moving body SMB1.

The position and the type are a position and a type that are acquired in The time of image capture is a time of image capture included in the sensor information SI acquired in Step S102a. The pieces of second moving body information MD2a to MD2c are pieces of information acquired based on the image data PD_T1 at a common time of image capture T1. Therefore, the time of image capture of each of the pieces of second moving body information MD2a to MD2c is “T1.” The second acquisition unit 105 holds the acquired second moving body information MD2. The second acquisition unit 105 returns to the surveillance processing illustrated in FIG. 2.

The correlation unit 106 correlates first moving body information MD1 and second moving body information MD2 that are related to a common moving body MB, based on the position of a held apparatus 107, and the position and the type of a sensor moving body SMB (Step S103).

The correlation unit 106 according to the present example embodiment correlates first moving body information MD1 and second moving body information MD2 that are related to a common moving body MB, based on the position and the moving velocity of a held apparatus 107, and the position and the type of a sensor moving body SMB.

The correlation unit 106 acquires the position and the velocity of a held apparatus 107 by using an apparatus ID and a position that are included in the first moving body information MD1 acquired in Step S101. Further, the correlation unit 106 acquires the position and the type of a sensor moving body SMB by using a sensor moving body ID, a position, and a type that are included in the second moving body information MD2 acquired in Step S102.

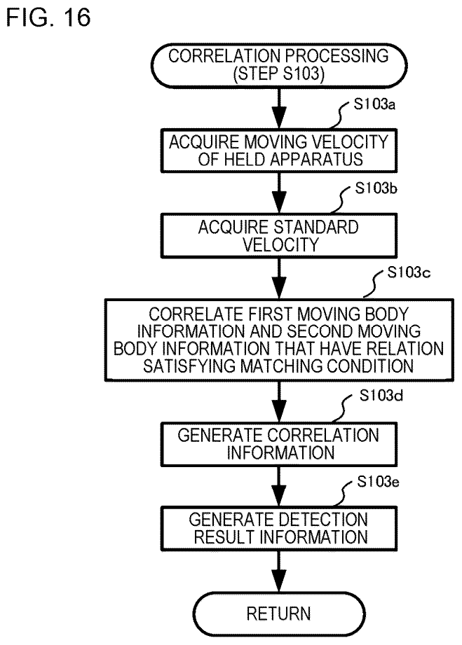

FIG. 16 is a flowchart illustrating an example of correlation processing according to the present example embodiment (Step S103).

The correlation unit 106 acquires the moving velocity of a held apparatus 107, based on the position of the held apparatus 107 (Step S103a) More specifically, for example, the correlation unit 106 acquires the moving velocity for each held apparatus 107 with an apparatus ID included in first moving body information MD1 acquired in the latest Step S101 (hereinafter referred to as “latest first moving body information MD1”).

For example, it is assumed that the first moving body information MD1 illustrated in FIG. 10 is the latest first moving body information MD1. The first moving body information MD1 includes pieces of the first moving body information MDla to d for apparatus IDs “CD1” to “CD4.” Therefore, the correlation unit 106 performs processing for acquiring the moving velocity for each of the pieces of the first moving body information MDla to d.

For example, for the first moving body information MDla, the correlation unit 106 acquires first past first moving body information MD1 including the same apparatus ID “CD1” (such as first moving body information MD1 including the apparatus ID “CD1” and including the closest time of measurement).

The correlation unit 106 acquires the time difference between a time of measurement included in the first moving body information MDla and a time of measurement included in the first past first moving body information MD1. The correlation unit 106 acquires the distance between a measurement position included in the first moving body information MDla and a measurement position included in the first past first moving body information MD1. The correlation unit 106 divides the distance by the time difference. As a result, the correlation unit 106 acquires the moving velocity of the held apparatus 107a.

The correlation unit 106 performs similar processing on each of the pieces of first moving body information MD1b to d. As a result, the correlation unit 106 acquires the moving velocity of each of the held apparatuses 107a to 107d.

Note that past first moving body information MD1 is not limited to first moving body information MD1 including the closest time of positioning. For example, the correlation unit 106 may acquire past first moving body information MD1 with use of a time of positioning preceding by a predetermined time or more as an additional condition.

The correlation unit 106 acquires a standard velocity of a sensor moving body SMB, based on the type of the sensor moving body SMB (Step S103b).

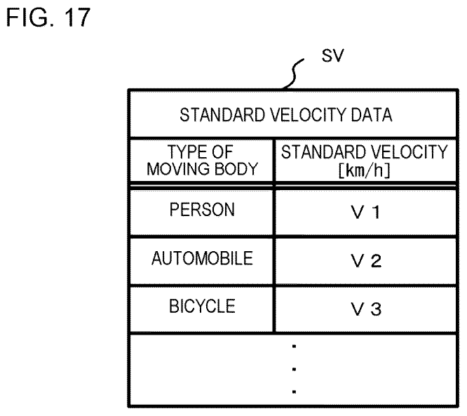

More specifically, for example, the correlation unit 106 previously holds standard velocity data indicating a standard velocity based on a type of moving body MB. FIG. 17 is a diagram illustrating an example of standard velocity data SV. The standard velocity data SV illustrated in the diagram are data in which a type of moving body MB and a standard velocity are associated with each other. For example, a standard velocity is a standard upper limit when a moving body MB the type of which is associated with the standard velocity moves. Note that an appropriate velocity may be set to a standard velocity.

The correlation unit 106 refers to the standard velocity data SV and acquires a standard velocity associated with the same type as the type of a sensor moving body SMB as the standard velocity of the sensor moving body SMB.

The correlation unit 106 correlates first moving body information MD1 and second moving body information MD2 that have a relation satisfying a matching condition (Step S103c).

The matching condition is a condition for correlating first moving body information MD1 and second moving body information MD2. The matching condition includes a condition A being a condition related to a time, a condition B being a condition related to a position, and a condition C being a condition related to a type of moving body MB.

The condition A is that the difference between a time of positioning and a time of image capture is within a predetermined time.

For example, the condition B is that “the position of a held apparatus 107 and the position of a moving body included in sensor information S1 match.” Note that a match of two positions includes not only a complete match of the two positions but also the two positions being positioned within a predetermined range.

For example, a condition C1 being an example of the condition C is that “the moving velocity of a held apparatus 107 is equal to or less than the standard velocity.” The correlation unit 106 decides whether the condition A is satisfied, based on a time of positioning included in first moving body information MD1 acquired in Step S101 and a time of image capture included in second moving body information MD2 acquired in Step S102c.

The correlation unit 106 decides whether the condition B is satisfied, based on a position included in the first moving body information MD1 acquired in Step S101 and the position of a moving body MB acquired in Step S102b.

The correlation unit 106 decides whether the condition C1 is satisfied, based on the moving velocity of a held apparatus 107 acquired in Step S103a and a standard velocity acquired in Step S103b.

The correlation unit 106 decides that the matching condition is satisfied when all the conditions A to C are satisfied. The correlation unit 106 decides that the matching condition is not satisfied when at least one of the conditions A to C is not satisfied.

The correlation unit 106 correlates first moving body information MD1 and second moving body information MD2 that have a relation satisfying the matching condition as first moving body information MD1 and second moving body information MD2 that are related to a common moving body.

For example, the first moving body information MD1 illustrated in FIG. 10 includes pieces of first moving body information MD1_a to MD1_d. Further, the second moving body information MD2 illustrated in FIG. 15 includes pieces of second moving body information MD2_a to MD2c.

In this example, the time of positioning of the pieces of first moving body information MD1_a to MD1_d is T1. The time of image capture of the pieces of second moving body information MD2_a to MD2_c is T1. Therefore, the pieces of first moving body information MD1_a to MD1_d and the pieces of second moving body information MD2_a to MD2_c have a relation satisfying the condition A.

The pieces of first moving body information MD1_a to MD1_d are pieces of information about the moving bodies MB1 to MB4, respectively. The pieces of second moving body information MD2_a, MD2_b, and MD2_c are pieces of information about the moving bodies MB1, MB4, and MB5, respectively.

Therefore, positions in the first moving body information MD1_a and the second moving body information MD2_a that are related to the moving body MB1 match. Positions in the first moving body information MD1_d and the second moving body information MD2_b that are related to the moving body MB4 match.

On the other hand, second moving body information MD2 related to the moving body MB2 or the moving body MB3 does not exist. Therefore, second moving body information MD2 including a position matching a position included in each of the pieces of first moving body information MD1_b and MD1_c does not exist. Further, first moving body information MD1 related to the moving body MB5 does not exist. Therefore, first moving body information MD1 including a position matching the position included in the second moving body information MD2_c does not exist.

The moving body MB1 is a person as illustrated in FIG. 3, and therefore, the moving velocity thereof is equal to or less than a standard velocity V1. The moving body MB4 is an automobile as illustrated in FIG. 3, and therefore, the moving velocity thereof is equal to or less than a standard velocity V2.

Thus, the first moving body information MD1_a and the second moving body information MD2_a satisfy the conditions A to C. The first moving body information MD1_d and the second moving body information MD2_b satisfy the conditions A to C.

As a result, the correlation unit 106 correlates the first moving body information MD1_a and the second moving body information MD2_a that are related to the common moving body MB1. The correlation unit 106 correlates the first moving body information MD1_d and the second moving body information MD2_b that are related to the common moving body MB4.

The correlation unit 106 generates correlation information MI indicating the result of correlation in Step S103c (Step S103d).

More specifically, for example, the correlation unit 106 generates authentication information (first information) COI, based on correlated pieces of information MD1 and MD2. The authentication information COI is information about a moving body MB authentication of which performed by correlating first moving body information MD1 and second moving body information MD2 is successful (an authenticated moving body).

Further, the correlation unit 106 generates suspicious moving body candidate information SCI, based on uncorrelated first moving body information MD1 or uncorrelated second moving body information MD2. The suspicious moving body candidate information SCI is information about a moving body MB authentication of which performed by correlating first moving body information MD1 and second moving body information MD2 is unsuccessful (a suspicious moving body candidate).

The correlation unit 106 generates correlation information MI including the authentication information COI and the suspicious moving body candidate information SCI. The correlation unit 106 holds the correlation information MI.

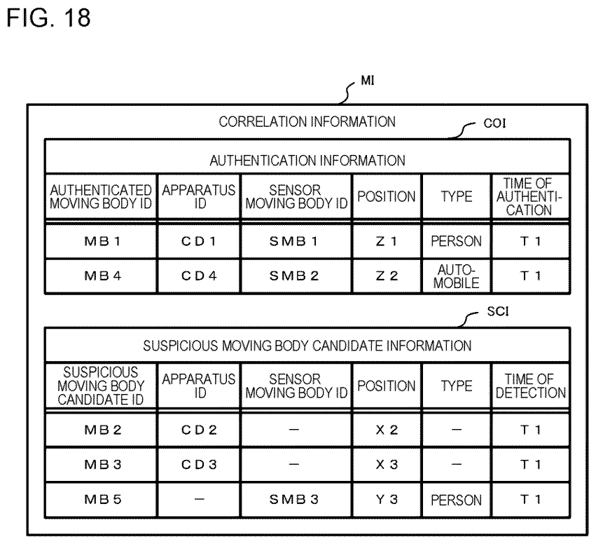

FIG. 18 is a diagram illustrating a first example of correlation information MI. The correlation information MI includes authentication information COI and suspicious moving body candidate information SCI.

The authentication information COI is information in which an authenticated moving body ID, an apparatus ID, a sensor moving body ID, a position, a type, and a time of detection are associated with each other.

The authenticated moving body ID is information for identifying an authenticated moving body. When first moving body information MD1 and second moving body information MD2 are correlated, the correlation unit 106 assigns an authenticated moving body ID, for example, in accordance with a predetermined rule.

The apparatus ID in the authentication information COI is an apparatus ID included in first moving body information MD1 out of first moving body information MD1 and second moving body information MD2 that are correlated with each other.

The sensor moving body ID in the authentication information COI is a sensor moving body ID included in the second moving body information MD2 out of the first moving body information MD1 and the second moving body information MD2 that are correlated with each other.

The position in the authentication information COI is a position acquired based on a position included in each piece of the first moving body information MD1 and the second moving body information MD2 that are correlated with each other. For example, the position in the authentication information COI is a position located midway between the position included in the first moving body information MD1 and the position included in the second moving body information MD2. The position in the authentication information COI is not limited to the above and, for example, may be a position included in either of the first moving body information MD1 and the second moving body information MD2.

The type in the authentication information COI is a type included in the second moving body information MD2 out of the first moving body information MD1 and the second moving body information MD2 that are correlated with each other.

The time of detection in the authentication information COI is a time when a moving body MB indicated by the first moving body information MD1 and the second moving body information MD2 that are correlated with each other is detected. For example, the time of detection is a time of positioning included in the first moving body information MD1 or a time of image capture included in the second moving body information MD2.

The suspicious moving body candidate information SCI is information in which a suspicious moving body candidate ID, an apparatus ID, a sensor moving body ID, a position, a type, and a time of detection are associated with each other.

The suspicious moving body ID is information for identifying a suspicious moving body candidate. When uncorrelated first moving body information MD1 and uncorrelated second moving body information MD2 exist, the correlation unit 106 assigns a suspicious moving body ID, for example, in accordance with a predetermined rule.

The apparatus ID in the suspicious moving body candidate information SCI is an apparatus ID included in first moving body information MD1. When first moving body information MD1 not correlated with second moving body information MD2 exists, the correlation unit 106 sets the apparatus ID in the suspicious moving body candidate information SCI.

The sensor moving body ID in the suspicious moving body candidate information SCI is a sensor moving body ID included in second moving body information MD2. When second moving body information MD2 not correlated with first moving body information MD1 exists, the correlation unit 106 sets the apparatus ID in the suspicious moving body candidate information SCI.

The position in the suspicious moving body candidate information SCI is a position included in uncorrelated first moving body information MD1 or uncorrelated second moving body information MD2.

The type in the suspicious moving body candidate information SCI is a type included in second moving body information MD2. When second moving body information MD2 not correlated with first moving body information MD1 exists, the correlation unit 106 sets the type of a moving body MB.

The time of detection in the suspicious moving body candidate information SCI is a time of positioning included in uncorrelated first moving body information MD1 or a time of image capture in uncorrelated second moving body information MD2. Specifically, when first moving body information MD1 not correlated with second moving body information MD2 exists, the correlation unit 106 sets the time of positioning to the time of detection in the suspicious moving body candidate information SCI. When second moving body information MD2 not correlated with first moving body information MD1 exists, the correlation unit 106 sets the time of image capture to the time of detection in the suspicious moving body candidate information SCI.

The correlation information MI illustrated in FIG. 18 is information acquired based on the first moving body information MD1 illustrated in FIG. 10 and the second moving body information MD2 illustrated in FIG. 15.

More specifically, the authentication information COI illustrated in FIG. 18 includes information about the first moving body information MD1_a and the second moving body information MD2_a that are correlated with each other and information about the first moving body information MD1_d and the second moving body information MD2_b that are correlated with each other.

The suspicious moving body candidate information SCI illustrated in FIG. 18 includes information about each of the pieces of first moving body information MD1 b and MD1_c and information about the second moving body information MD2_c.

FIG. 16 is referred to again.

The correlation unit 106 generates detection result information DRI about a moving body MB detected in the surveillance area MA (Step S103e).

More specifically, the correlation unit 106 determines information about a moving body MB to be excluded from the suspicious moving body candidate information SCI. The moving body MB to be excluded has only to be predetermined and is, for example, a moving body MB indicated by the suspicious moving body candidate information SCI based on first moving body information MD1.

The correlation unit 106 generates holding body information (second information) HBI including information about the determined moving body MB. The holding body information HBI is information about a moving body MB indicated by first moving body information MB1 not correlated with second moving body information MB2 (a holding moving body).

The holding body information HBI generates suspicious moving body information (third information) SOI by excluding the information about the determined moving body MB from the suspicious moving body candidate information SCI. The suspicious moving body information SOI is information about a moving body MB indicated by second moving body information MB2 not correlated with first moving body information MB1 (a suspicious moving body MB).

The aforementioned suspicious moving body candidate information SCI based on first moving body information MD1 is information about a moving body MB holding a held apparatus 107. Since a held apparatus 107 is held by a moving body MB permitted to enter the surveillance area MA, the possibility of a moving body MB holding a held apparatus 107 not being a suspicious moving body MB is high. Therefore, information based on first moving body information MD1 is excluded from the suspicious moving body candidate information SCI.

Accordingly, the holding body information HBI is information about an unsuccessfully authenticated moving body MB with a high possibility of not being a suspicious moving body MB. The suspicious moving body information SOI is information about a suspicious moving body MB.

The correlation unit 106 generates detection result information DRI including the authentication information COI, the holding body information HBI, and the suspicious moving body information SOI. The correlation unit 106 holds the detection result information DRI. The correlation unit 106 returns to the surveillance processing.

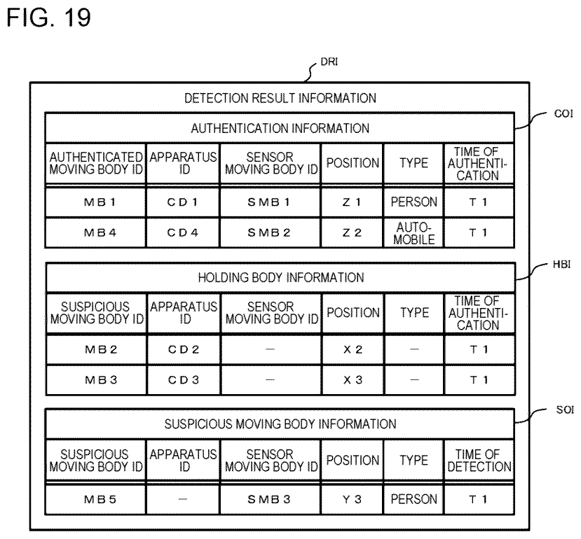

FIG. 19 is a diagram illustrating an example of detection result information DRI. The detection result information DRI illustrated in the diagram is detection result information DRI generated based on the correlation information MI illustrated in FIG. 18.

The authentication information COI included in the detection result information DRI is the same as the authentication information COI included in the correlation information MI.

Each of the holding body information HBI and the suspicious moving body information SOI is configured with information similar to the suspicious moving body candidate information SCI. The holding body information HBI illustrated in FIG. 19 includes information about the pieces of first moving body information MD1_b and MD1_c. The suspicious moving body information SOI illustrated in FIG. 19 is information acquired by excluding information about the pieces of first moving body information MD1_b an dMD1_c from the suspicious moving body candidate information SCI illustrated in FIG. 18.

Note that the correlation unit 106 may generate one or a plurality of pieces of information out of the authentication information COI, the holding body information HBI, and the suspicious moving body information SOI.

FIG. 2 is referred to again.

The first acquisition unit 104 executes Step S101 again. The surveillance apparatus 101 repeatedly executes Steps S101 to S103. As a result, the surveillance apparatus 101 can continuously correlate pieces of information MD1 and MD2 related to a common moving body MB in real time. Therefore, authentication of a moving body MB and detection of a suspicious moving body MB in the surveillance area MA can be performed in real time.

At this time, the first acquisition unit 104 may execute Step S101 again after a predetermined time elapses since execution of Step S103c. Thus, the surveillance apparatus 101 can continuously transmit real-time correlation at predetermined time intervals. Authentication of a moving body MB in the surveillance area MA and detection of a suspicious moving body MB can be performed in real time in this case as well.

The first example embodiment of the present invention has been described above.

The surveillance apparatus 101 according to the present example embodiment includes the first acquisition unit 104, the second acquisition unit 105, and the correlation unit 106.

The first acquisition unit 104 acquires first moving body information MD1 including the position of a held apparatus 107 held by a predetermined moving body MB. The second acquisition unit 105 acquires second moving body information MD2 including the position and the type of a sensor moving body SMB being a moving body MB detected based on sensor information SI generated by the sensor apparatus 103. The correlation unit 106 correlates first moving body information MD1 and second moving body information MD2 that are related to a common moving body MB, based on the position of a held apparatus 107, and the position and the type of a sensor moving body SMB.

In general, a position measured by the positioning system 102 normally has a measurement error. A position acquired based on image data PD also normally has an error. Therefore, for example, when a plurality of moving bodies MB holding held apparatuses 107 are positioned relatively close to each other, using only the positions of held apparatuses 107 and a sensor moving body SMB may hinder correct correlation of pieces of information MB1 and MB2.

According to the present example embodiment, pieces of information MB1 and MB2 can be correlated by using the moving velocity of a held apparatus 107 acquired based on the position of the held apparatus 107 and the type of a sensor moving body SMB. Therefore, pieces of information MB1 and MB2 can be correlated by using not only the positions of a held apparatus 107 and a sensor moving body SMB but also the moving velocity of the held apparatus 107 and the type of the sensor moving body SMB. As a result, pieces of information MB1 and MB2 can be correlated more accurately compared with a case of correlating the pieces of information MB1 and MB2 by using only the positions of a held apparatus 107 and a sensor moving body SMB. Accordingly, a moving body MB can be precisely determined.

According to the present example embodiment, the correlation unit 106 correlates first moving body information MD1 and second moving body information MD2 that are related to a common moving body MB, further based on a moving velocity acquired based on the position of a held apparatus 107.

Therefore, by using the moving velocity of a held apparatus 107 and the type of a sensor moving body SMB, first moving body information MB1 and second moving body information MB2 can be correlated more accurately compared with a case of using only positions. Accordingly, a moving body MB can be precisely detected.

### Modified Example 1

An example of the communication apparatus 108 acquiring the position of a held apparatus 107, based on an electromagnetic wave EW transmitted by the held apparatus 107, has been described in the first example embodiment. In this modified example, an example of a held apparatus 107 acquiring the position of the held apparatus 107, based on an electromagnetic wave EW from the communication apparatus 108, will be described.

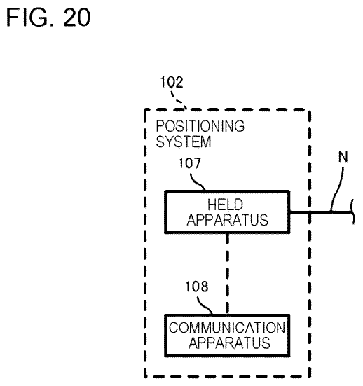

FIG. 20 is a diagram illustrating an example of a configuration of a positioning system 102 according to the modified example 1.

For example, a communication apparatus 108 transmits an electromagnetic wave EW for positioning at predetermined time intervals.

A held apparatus 107 receives the electromagnetic wave EW for positioning transmitted from the communication apparatus 108. The held apparatus 107 acquires the position of the held apparatus 107, based on the reception intensity, the direction, and the like of the received electromagnetic wave EW for positioning. The held apparatus 107 generates first moving body information MD1 including the position of the held apparatus 107. The held apparatus 107 transmits the first moving body information MD1 to a surveillance apparatus 101 through a network N.

In this modified example, the held apparatus 107 further includes a network interface 1070.

Positioning processing according to this modified example will be described with reference to FIG. 9. For example, the communication apparatus 108 executes Step S203 at predetermined time intervals. The held apparatus 107 repeatedly executes Steps S204 to S207.

This modified example also provides effects similar to those provided by the first example embodiment.

### Modified Example 2

An example of the correlation unit 106 using the position of a held apparatus 107, and the position and the type of a sensor moving body SMB for correlating first moving body information MD1 and second moving body information MD2 that are related to a common moving body MB has been described in the first example embodiment. In this modified example, another example of a method of the correlation unit 106 correlating first moving body information MD1 and second moving body information MD2 that are related to a common moving body MB, based on the position of a held apparatus 107, and the position and the type of a sensor moving body SMB, will be described.

A correlation unit 106 according to this modified example acquires the type of a moving body MB holding a held apparatus 107, based on first moving body information MD1 acquired by a first acquisition unit 104, instead of acquiring the moving velocity of the held apparatus 107.

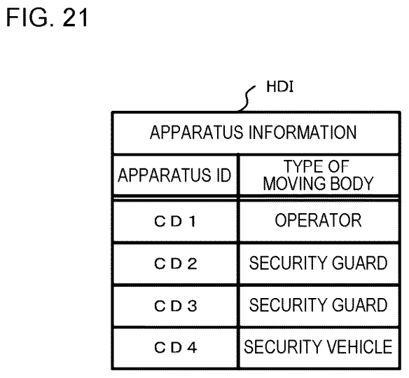

Therefore, for example, the correlation unit 106 according to this modified example previously holds apparatus information HDI as illustrated in FIG. 21.

FIG. 21 is a diagram illustrating an example of apparatus information HDI.

Apparatus information HDI is information in which an apparatus ID and the type of a moving body MB holding a held apparatus 107 indicated by the apparatus ID are associated with each other.

The correlation unit 106 determines an apparatus ID included in first moving body information MD1 acquired by the first acquisition unit 104. The correlation unit 106 acquires the type of a moving body MB associated with the determined apparatus ID, based on the apparatus information HDI.

The correlation unit 106 according to this modified example correlates first moving body information MD1 and second moving body information MD2 that are related to a common moving body MB, based on the position of a held apparatus 107, and the position and the type of a sensor moving body SMB.

The correlation unit 106 according to this modified example correlates first moving body information MD1 and second moving body information MD2 that are related to a common moving body MB, further based on the type of a moving body MB holding a held apparatus 107 acquired based on an apparatus ID.

In this modified example, an apparatus ID included in first moving body information MD1 is an example of determination information for determining the type of a moving body MB.

In other words, the correlation unit 106 according to this modified example correlates first moving body information MD1 and second moving body information MD2 that are related to a common moving body MB, based on determination information, the position of a held apparatus 107, and the position and the type of a sensor moving body SMB.

Note that determination information is not limited to an apparatus ID of a held apparatus 107 and may be a moving body ID being information for identifying a moving body MB holding a held apparatus 107 or information indicating the type of the moving body MB holding the held apparatus 107. In such a case, for example, a user preferably presets the moving body ID, the type of the moving body MB, or the like to the held apparatus 107.

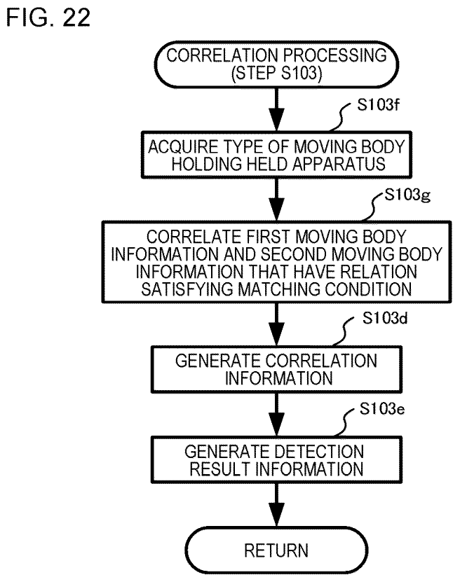

The correlation unit 106 according to this modified example executes Step S103 illustrated in FIG. 22 instead of Step S103 according to the first example embodiment. FIG. 22 is a flowchart illustrating an example of correlation processing according to this modified example (Step S103).

The correlation unit 106 determines an apparatus ID included in first moving body information MD1 acquired in Step S101. The correlation unit 106 acquires the moving velocity of a held apparatus 107, based on the position of the held apparatus 107 (Step S103f).

The correlation unit 106 correlates first moving body information MD1 and second moving body information MD2 that have a relation satisfying a matching condition (Step S103g).

The matching condition according to this modified example includes conditions A and B similar to those according to the first example embodiment. The matching condition according to this modified example includes a condition C2 being another example of a condition C being a condition related to a type of moving body MB. The condition C2 is that the type of a moving body MB acquired based on an apparatus ID is the same as the type of a sensor moving body SMB.

Similarly to the first example embodiment, the correlation unit 106 decides that the matching condition is satisfied when all the conditions A to C are satisfied in this modified example as well. Similarly to the first example embodiment, the correlation unit 106 decides that the matching condition is not satisfied when at least one of the conditions A to C is not satisfied. The correlation unit 106 correlates first moving body information MD1 and second moving body information MD2 that have a relation satisfying the matching condition as first moving body information MD1 and second moving body related to a common moving body.

The correlation unit 106 executes Step S103d similar to that in the first example embodiment.

Note that preparation processing may not be executed in this modified example.

According to this modified example, first moving body information MD1 includes an apparatus ID as determination information for determining the type of a moving body MB holding a held apparatus 107. The correlation unit 106 correlates first moving body information MD1 and second moving body information MD2 that are related to a common moving body MB, based on determination information, the position of a held apparatus 107, and the position and the type of a sensor moving body SMB.

The correlation unit 106 can acquire the type of a moving body MB holding a held apparatus 107 by using determination information. Therefore, by using the type of a moving body MB holding a held apparatus 107 and the type of a sensor moving body SMB, first moving body information MB1 and second moving body information MB2 can be more accurately correlated compared with a case of using only positions. Accordingly, a moving body MB can be precisely detected.

### Modified Example 3

A positioning system 102 measures the position of a held apparatus 107 by using an electromagnetic wave EW. Therefore, the measurement precision of the position of a held apparatus 107 may be degraded due to an effect of propagation status of an electromagnetic wave EW, or the like. An example of changing a correlation method according to the measurement precision of the position of a held apparatus 107 will be described in this modified example.

A correlation unit 106 acquires a first confidence level being a confidence level of a position included in first moving body information, based on a predetermined first factor. The correlation unit 106 correlates first moving body information MD1 and second moving body information MD2 that are related to a common moving body MB, based on the position of a held apparatus 107 where the first confidence level satisfies a first condition, and the position and the type of a sensor moving body SMB.

For example, the first factor includes at least one of the following factors A to D.

The factor A is the reception intensity of an electromagnetic wave EW used for positioning of a held apparatus 107. As the reception intensity decreases, the positioning precision of the positioning system 102 is degraded.

A communication apparatus 108 generates first moving body information MD1 including the reception intensity of an electromagnetic wave EW and transmits the information to a surveillance apparatus 101. The correlation unit 106 acquires the reception intensity of the electromagnetic wave EW, based on the first moving body information MD1.

The factor B is a positional relation between the communication apparatus 108 transmitting or receiving an electromagnetic wave EW and a held apparatus 107. For example, the positional relation is the distance between the communication apparatus 108 and a held apparatus 107, and the direction of the held apparatus 107 viewed from the communication apparatus 108. As the distance increases, the positioning precision of the positioning system 102 is degraded. As the angular difference between the direction of a held apparatus 107 viewed from the communication apparatus 108 and, for example, a predetermined standard direction increases, the positioning precision of the positioning system 102 is degraded.

The correlation unit 106 acquires a positional relation between the communication apparatus 108 and a held apparatus 107, based on image data PD included in sensor information SI.

The factor C is whether an obstacle obstructing propagation of an electromagnetic wave EW exists between a held apparatus 107 and the communication apparatus 108. When an obstacle, such as an automobile, exists between a held apparatus 107 and the communication apparatus 108, the obstacle obstructs propagation of an electromagnetic wave EW. The positioning precision of the positioning system 102 when an obstacle exists is degraded compared with a case of nonexistence of an obstacle.

The correlation unit 106 decides existence of an obstacle, based on image data PD included in sensor information SI.

The factor D is the orientation of a moving body MB relative to the communication apparatus 108. For example, it is assumed that a moving body MB is a person and carries a held apparatus 107 hung from the neck. In this case, when the person is in a direction of turning the back of the person on the communication apparatus 108, the body becomes an obstacle obstructing propagation of an electromagnetic wave EW, which degrades the positioning precision compared with a case of the person being in a direction of turning the front of the person on the communication apparatus 108.

The correlation unit 106 acquires direction information indicating the orientation of a moving body MB relative to the communication apparatus 108, based on image data PD included in sensor information SI.

For example, the correlation unit 106 acquires a first confidence level, based on a relational expression including at least one of the factors A to D as a parameter. The relational expression is preferably defined experimentally.

The first condition is a condition related to a first confidence level and includes being equal to or greater than a predetermined confidence level as a condition.

The correlation unit 106 correlates first moving body information MD1 and second moving body information MD2 that are related to a common moving body MB, based on the position of a held apparatus 107 where the first confidence level satisfies the first condition, and the position and the type of a sensor moving body SMB.

The correlation unit 106 according to this modified example uses the position of a held apparatus 107 where the first confidence level satisfies the first condition out of the positions of held apparatuses 107 included in first moving body information for correlation of pieces of information MD1 and MD2. Therefore, correlation can be performed based on high-precision information.

Accordingly, a moving body MB can be precisely detected.

### Modified Example 4

An example of not using the position of a held apparatus 107 where the first confidence level does not satisfy the first condition in correlation of pieces of information MD1 and MD2 has been described in the modified example 3. However, the matching condition may be changed according to a first confidence level.

A correlation unit 106 according to this modified example changes the condition B included in the matching condition according to a first confidence level. For example, as a first confidence level decreases, a predetermined range for deciding a match of two positions is widened.

This modified example can reduce the possibility of erroneous correlation based on a position with a low first confidence level. Accordingly, a moving body MB can be precisely detected.

### Modified Example 5

A second acquisition unit 105 acquires the position of a sensor moving body SMB, based on sensor information. For example, the image quality of an image included in sensor information may be degraded outdoors due to an effect of a sensing environment such as the sunlight, and the precision of the position of a sensor moving body SMB may be degraded. An example of changing a correlation method according to the precision of the position of a sensor moving body SMB will be described in this modified example.

The second acquisition unit 105 acquires a second confidence level being a confidence level of the position of a sensor moving body SMB. For example, when the position and the type of a sensor moving body SMB is acquired by using a learning model, a learning model according to this modified example further outputs a second confidence level.

A correlation unit 106 correlates first moving body information MD1 and second moving body information MD2 that are related to a common moving body MB, based on the position of a held apparatus 107, and the position and the type of a sensor moving body SMB, the second confidence level of the position satisfying a second condition.

The second condition is a condition related to a second confidence level and includes that the second confidence level is equal to or greater than a predetermined confidence level as a condition.

The correlation unit 106 according to this modified example uses a position the second confidence level of which satisfies the second condition out of the positions of sensor moving bodies SMB acquired based on sensor information in correlation of pieces of information MD1 and MD2. Therefore, correlation can be performed based on high-precision information. Accordingly, a moving body MB can be precisely detected.

### Modified Example 6

An example of not using a position of a sensor moving body SMB the second confidence level of which does not satisfy the first condition in correlation of pieces of information MD1 and MD2 has been described in the modified example 5. However, the matching condition may be changed according to a second confidence level.

A correlation unit 106 according to this modified example changes the condition B included in the matching condition according to a second confidence level. For example, as a second confidence level decreases, a predetermined range for deciding a match of positions is widened.

This modified example can reduce the possibility of erroneous correlation based on a position with a low second confidence level. Accordingly, a moving

### Modified Example 7

A correlation unit 106 may correct one or both of a position included in first moving body information MD1 and the position of a sensor moving body SMB. When a position included in first moving body information MD1 is corrected, the correlation unit 106 correlates pieces of information MD1 and D2 related to a common moving body MB by using a position acquired by correcting the position included in the first moving body information MD1. When a position included in second moving body information MD2 is corrected, the correlation unit 106 correlates pieces of information MD1 and D2 related to a common moving body MB by using the corrected position of a sensor moving body SMB.

More specifically, the correlation unit 106 corrects a position included in first moving body information MD1. In this case, the correlation unit 106 correlates first moving body information MD1 and second moving body information MD2 that are related to a common moving body MB, based on the corrected position, and the position and the type of a sensor moving body SMB.

Further, the correlation unit 106 corrects the position of a sensor moving body SMB. In this case, the correlation unit 106 correlates first moving body information MD1 and second moving body information MD2 that are related to a common moving body MB, based on the position of a held apparatus 107, the corrected position of the sensor moving body SMB, and the type of the sensor moving body SMB.

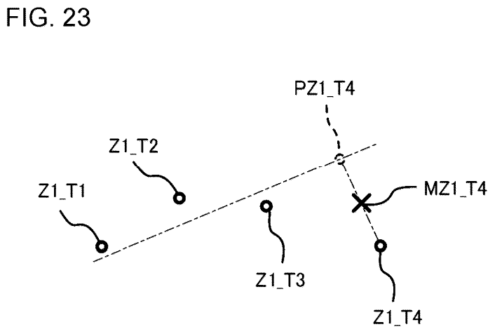

FIG. 23 is a diagram for illustrating an example of a method for correcting a position.

The correlation unit 106 predicts a position PZ1_T4 at a time T4, based on position histories Z1_T1, Z1_T2, and Z1_T3. The positions Z1_T1, Z1_T2, and Z1_T3 in FIG. 23 represent positions at times T1, T2, and T3. A time T4 is a time after the times T1, T2, and T3. For example, the correlation unit 106 predicts the position PZ1_T4 at the time T4, based on an approximate straight When a position Z1_T4 exceeds a predetermined range from the predicted position PZ1_T4, the correlation unit 106 corrects the position Z1_T4 included in first moving body information MD1. The position Z1_T4 is a position included in first moving body information MD1 or the position of a sensor moving body SMB. For example, the correlation unit 106 sets a position located midway between the predicted position PZ1_T4 and the position Z1_T4 included in the first moving body information MD1 to a corrected position MZ1_T4. The position MZ1_T4 in FIG. 23 indicates the corrected position.

This modified example makes a correction and therefore can acquire a more accurate position. Therefore, the possibility of erroneous correlation can be reduced. Accordingly, a moving body MB can be precisely detected.

### Second Example Embodiment

An example of causing a display unit to display a result of correlation by a surveillance apparatus 101 will be described in the present example embodiment.

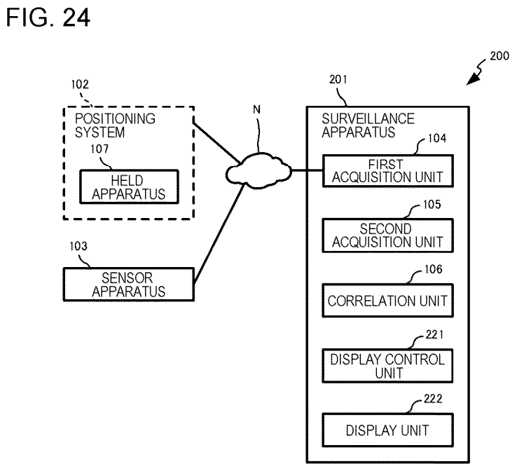

FIG. 24 is a diagram illustrating an overview of a surveillance system 200 according to the second example embodiment of the present invention. The surveillance system 200 includes a surveillance apparatus 201 in place of the surveillance apparatus 101 according to the first example embodiment. The surveillance apparatus 201 includes a display control unit 221 and a display unit 222 in addition to the configuration included in the surveillance apparatus 101 according to the first example embodiment. Except for the above, the surveillance system 200 is preferably configured similarly to the surveillance system 100 according to the first example embodiment.

The display control unit 221 causes the display unit 222 to display various types of information. The display unit 222 displays the various types of information in accordance with control by the display control unit 221.

For example, the display control unit 221 causes the display unit 222 to display a detection result information DRI. Note that the display control unit 221 may cause the display unit 222 to display one or a plurality of pieces of information out of authentication information COI, holding body information HBI, and suspicious moving body information SOI.

A physical configuration of the surveillance system 200 may be similar to that of the surveillance system 100 according to the first example embodiment.

### Operation of Surveillance System 200

The surveillance system 200 executes positioning processing and sensing processing that are similar to those according to the first example embodiment.

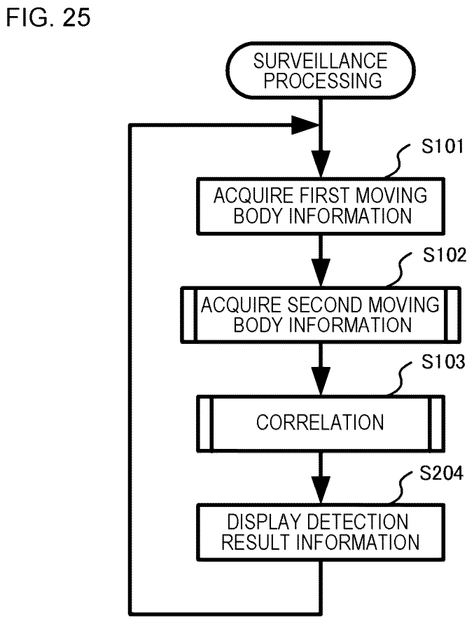

FIG. 25 is a flowchart illustrating an example of surveillance processing according to the present example embodiment. In the surveillance processing according to the present example embodiment, the surveillance apparatus 201 executes Step S204 after executing Steps S101 to S103 that are similar to those according to the first example embodiment.

The display control unit 221 causes the display unit 222 to display detection result information DRI (Step S204).

More specifically, for example, the display control unit 221 causes the display unit 222 to display a mapping diagram acquired by mapping a position included in detection result information DRI onto a diagram indicating a surveillance area M. The diagram indicating the surveillance area MA is a bird's eye view, a plan view, or the like of the surveillance area MA.

For example, depending on whether a position to be mapped on the mapping diagram is included in authentication information COI, holding body information HBI, or suspicious moving body information SOI, the display control unit 221 may cause the display unit 222 to display the position included in the information in a varying style. A varying style in display refers to the shape of a mark indicating a position, the color of the mark, whether the mark blinks, the blinking velocity of the mark, or the like.

For example, the display control unit 221 causes the display unit 222 to display a mapping diagram including a shielded region SA. The shielded region SA is a region in which propagation of an electromagnetic wave EW used for positioning of a held apparatus 107 is obstructed when viewed from a communication apparatus 108 transmitting or receiving the electromagnetic wave EW.

In general, propagation of an electromagnetic wave EW may be obstructed with a relatively large object such as an automobile, a person, or the like interposed between a held apparatus 107 and the communication apparatus 108 as an obstacle. The display control unit 221 determines a region more distant than an obstacle obstructing propagation of an electromagnetic wave EW when viewed from the communication apparatus 108 as the shielded region SA.

For example, an object such as an automobile or a pillar provided in the surveillance area MA is predetermined as an obstacle. The display control unit 221 determines an obstacle by applying image processing to image data PD.

For example, a region more distant than an obstacle is a region more distant than the obstacle when viewed from the communication apparatus 108 in a region enclosed by straight lines connecting the communication apparatus 108 to the outer edges of the obstacle.

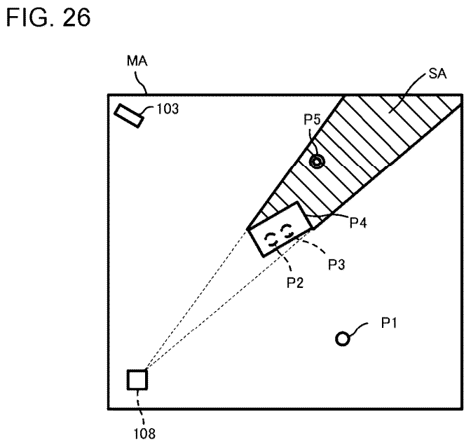

FIG. 26 is a diagram illustrating an example of a mapping diagram. P1 to P5 in the diagram indicate moving bodies MB1 to MB5, respectively.

The positions P1 and P4 indicated by solid circles in the diagram are positions included in authentication information COI. The positions P2 and P3 indicated by dotted circles are positions included in holding body information HBI. The position P5 indicated by a double circle is a position included in suspicious moving body information SOI.

Further, a hatched region in the diagram is a shielded region SA. Note that the method for indicating a shielded region SA in a mapping diagram may be changed as appropriate.

There is a high possibility that the precision of the position of a held apparatus 107 existing in the shielded region SA is low even when the position can be measured by a positioning system 102. Therefore, when a position based on authentication information COI or holding body information HBI exists in the shielded region SA in the mapping diagram, a user can easily recognize that the position may have a large error by referring to the mapping diagram.

Note that the display control unit 221 may cause the display unit 222 to display a position included in one or a plurality of pieces of information out of authentication information COI, holding body information HBI, and suspicious moving body information SOI in a style different from that for a position included in the other information in the mapping diagram. The display control unit 221 may cause the display unit 222 to display each position in the mapping diagram in a different style depending on the type of a moving body MB related to the position. The display control unit 221 may cause the display unit 222 to display the mapping diagram by using text, a table, and/or the like.

The second example embodiment of the present invention has been described above.

The display control unit 221 according to the present example embodiment causes the display unit 222 to display a mapping diagram acquired by mapping a position included in detection result information DRI onto a diagram indicating the surveillance area MA. A position included in the detection result information DRI is the position of a moving body MB detected by the surveillance system 100. Therefore, a user can easily recognize the position of a moving body MB in the surveillance area MA by referring to the mapping diagram. Accordingly, user convenience can be improved.

A mapping diagram according to the present example embodiment includes a shielded region SA being a region in which propagation of an electromagnetic wave EW used for positioning of a held apparatus 107 is obstructed when viewed from the communication apparatus 108 transmitting or receiving the electromagnetic wave EW.

### Third Example Embodiment

An example of making notification based on a result of correlation by a surveillance apparatus 101 will be described in the present example embodiment.

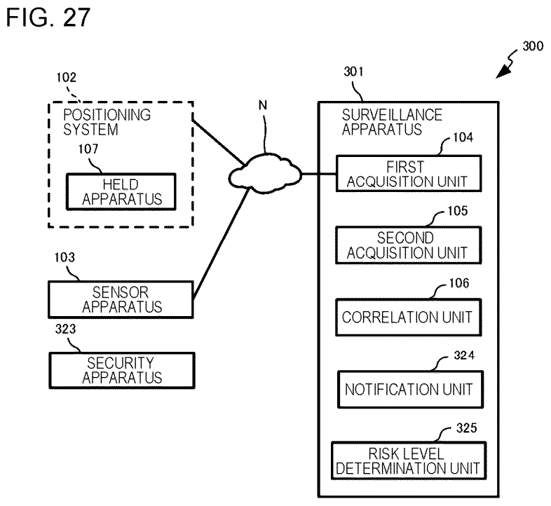

FIG. 27 is a diagram illustrating an overview of a surveillance system 300 according to the third example embodiment of the present invention. The surveillance system 300 includes a surveillance apparatus 301 in place of the surveillance apparatus 301 according to the first example embodiment. The surveillance system 300 further includes a security apparatus 323.

The security apparatus 323 is an example of a predetermined apparatus and is an apparatus used for security. The security apparatus 323 is connected to the surveillance apparatus 301 through a network N. For example, the security apparatus 323 is an apparatus equipped on a security vehicle and informs a person on board (such as a security guard) of notification information to be described later by using image display, voice, or the like.

The surveillance apparatus 301 includes a notification unit 324 and a risk level determination unit 325 in addition to the configuration included in the surveillance apparatus 101 according to the first example embodiment. Except for the above, the surveillance system 300 is preferably configured similarly to the surveillance system 100 according to the first example embodiment.

When second moving body information MD2 not correlated with first moving body information MD1 exists, the notification unit 324 notifies a held apparatus 107 or the security apparatus 323 of notification information.

Notification information is information for making notification of detection of a suspicious moving body MB in a surveillance area MA. For example, notification information includes a position included in second moving body information MD2 not correlated with first moving body information MD1.

### The risk level determination unit 325 determines a risk level of a suspicious moving body MB.

For example, a display control unit 221 causes a display unit 222 to display detection result information DRI. Note that the display control unit 221 may cause the display unit 222 to display one or a plurality of pieces of information out of authentication information COI, holding body information HBI, and suspicious moving body information SOI.

A physical configuration of the surveillance system 200 may be similar to that of the surveillance system 100 according to the first example embodiment. A physical configuration of the security apparatus 323 may be similar to that of the surveillance apparatus 301.

### Operation of Surveillance System 300

The surveillance system 300 executes positioning processing and sensing processing that are similar to those according to the first example embodiment.

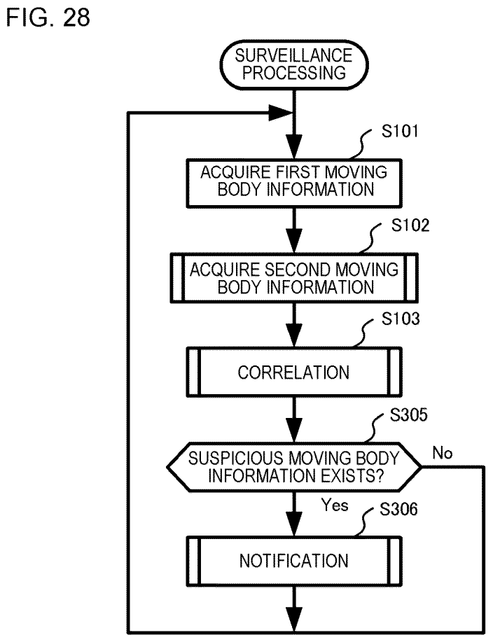

FIG. 28 is a flowchart illustrating an example of surveillance processing according to the present example embodiment. In the surveillance processing according to the present example embodiment, the surveillance apparatus 201 executes Step S305 after executing Steps S101 to S103 that are similar to those according to the first example embodiment.

The notification unit 324 decides whether suspicious moving body information SOI exists (Step S305).

As described above, suspicious moving body information SOI is information about a suspicious moving body MB indicated by second moving body information MB2 not correlated with first moving body information MB1. Accordingly, the notification unit 324 can decide whether second moving body information MB2 not correlated with first moving body information MD1 exists by executing Step S305. In other words, the notification unit 324 can decide whether a suspicious moving body MB exists in the surveillance area MA.

For example, in Step S305, the notification unit 324 may decide whether second moving body information MB2 not correlated with first moving body information MB1 exists longer than a predetermined time.

For example, in Step S305, the notification unit 324 may decide whether second moving body information MB2 not correlated with first moving body information MB1 stays in a predetermined area longer than a predetermined time.

For example, in Step S305, the notification unit 324 may decide whether the number N1of held apparatuses 107 in the surveillance area MA differs from the number N2 of suspicious moving bodies MB in the surveillance area MA and suspicious moving body information SOI exists.

In this case, for example, the notification unit 324 acquires the number of apparatus IDs included in authentication information COI and holding body information HBI that include positions in the surveillance area MA as the first number N1. For example, the notification unit 324 acquires the number of pieces of suspicious moving body information SOI including a position in the surveillance area MA (such as the number of sensor moving bodies ID) as the number N2 of suspicious moving bodies MB in the surveillance area MA.

When suspicious moving body information SOI is decided not to exist (Step S305: No), a first acquisition unit 104 executes Step S101.

When suspicious moving body information SOI is decided to exist (Step S305: Yes), the notification unit 324 makes notification of notification information (Step S306).

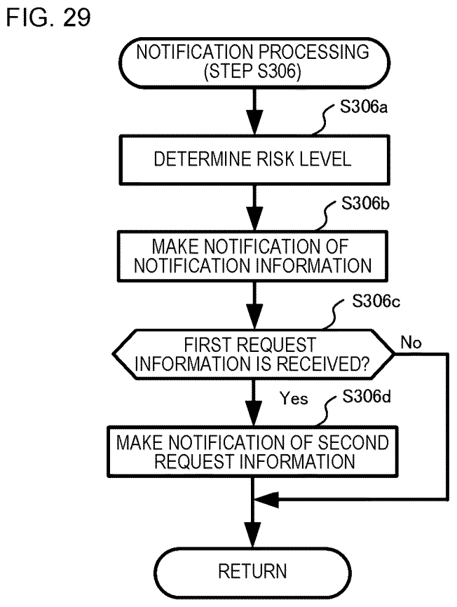

FIG. 29 is a flowchart illustrating an example of notification processing according to the present example embodiment (Step S305).

The risk level determination unit 325 determines a risk level of a suspicious moving body MB (Step S306a).

For example, the risk level determination unit 325 determines a risk level, based on the difference between the number N3 of security guards in a first region within a predetermined range from the position of a suspicious moving body MB and the number N2 of suspicious moving bodies MB in the surveillance For example, the risk level determination unit 325 determines the first region, based on a position included in suspicious moving body information SOI. For example, the first region is a region within a predetermined distance D1 from a position included in suspicious moving body information SOI. The notification unit 324 acquires apparatus IDs included in authentication information COI and holding body information HBI that include positions in the first region. The notification unit 324 refers to apparatus information HDI (see FIG. 21) and acquires the number of apparatus IDs associated with “security guard” out of the acquired apparatus IDs. The number of apparatus IDs associated with “security guard” is the number N3 of security guards in the first region.

When the number N2 of suspicious moving bodies MB is greater than the number N3 of security guards in the first region, the risk level determination unit 325 determines a risk level greater than that in a case of the number N3 of security guards in the first region being the number N2 of suspicious moving bodies MB. For example, such a risk level is the difference between the number N2 of suspicious moving bodies MB and the number N3 of security guards in the first region.

Further, for example, by using a microwave, a radar, or the like, the risk level determination unit 325 determines a risk level of a suspicious moving body MB, based on whether the suspicious moving body MB carries a dangerous article such as a knife or a gun. A generally known technology may be used as a technology for deciding whether a dangerous article is carried (for example, see https://jpn.nec.com/techrep/journal/g21/n01/pdf/210121.pdf).

Note that the display control unit 221 according to the third example embodiment may acquire a risk level and generate suspicious moving body information SOI including the risk level.

The notification unit 324 notifies a held apparatus 107 or the security apparatus 323 of notification information (Step S306b).

The notification unit 324 notifies a held apparatus 107 of notification information through the network N and a communication apparatus 108. The notification unit 324 notifies the security apparatus 323 of notification information through the network N.

For example, the notification unit 324 makes notification of notification information including a risk level determined in Step S306a.

For example, the notification unit 324 determines a held apparatus 107 held by a security guard positioned in the first region and notifies the determined held apparatus 107 of notification information.

For example, the notification unit 324 refers to apparatus information HDI (see FIG. 21) and determines an apparatus ID associated with “security guard” out of apparatus IDs in authentication information COI and holding body information HBI including positions in the first region. The determined apparatus ID is information indicating a held apparatus 107 held by a security guard positioned in the first region. The notification unit 324 notifies the determined apparatus ID of notification information. Note that authentication information COI and holding body information HBI are information based on first moving body information.

For example, the notification information in this case may include an instruction to go to the position of a sensor moving body SMB (a position included in second moving body information MD). Further, for example, the notification information may include a content based on a risk level (such as a risk level). Furthermore, for example, when the risk level determination unit 325 detects a dangerous article, the notification information may include the details of the dangerous article.

The notification unit 324 decides whether first request information is received from a held apparatus 107 positioned in a second region within a predetermined range from the position of a suspicious moving body MB (Step S306c).

First request information is information including a request from a person holding a held apparatus 107, such as a security guard. For example, the request is a request for reinforcement for handling of a suspicious moving body MB. The second region is narrower than the first region. For example, the second region is a region within a predetermined distance D2 from a position included in suspicious moving body information SOI. The distance D2 is a distance shorter than the distance D1.

Since first request information is transmitted from a held apparatus 107 positioned in the second region, a moving body MB holding the held apparatus 107 exists close to a suspicious moving body MB. When handling of the suspicious moving body MB is difficult, the moving body MB transmits first request information by using the held apparatus 107. A held apparatus 107 transmitting first request information is typically a held apparatus 107 held by a security guard but may be a held apparatus 107 held by a person other than a security guard. For example, a held apparatus 107 transmitting first request information may be a held apparatus 107 held by an operator discovering a suspicious moving body MB.

When deciding that first request information is not received (Step S306c: No), the notification unit 324 returns to the surveillance processing (see FIG. 28). The first acquisition unit 104 executes Step S101.

When deciding that first request information is received (Step S306c: No), the notification unit 324 notifies a held apparatus 107 other than the held apparatus 107 transmitting the first request information of second request information (Step S306d).

Second request information is information for a person holding a held apparatus 107, such as a security guard, to request reinforcement. Second request information is information notified when first request information is received from a held apparatus 107 held by a security guard or the like who is close to a suspicious moving body MB. Therefore, when notification of second request information is made, the security guard or the like close to the suspicious moving body MB may be exposed to danger. Therefore, second request information may include an instruction to urgently go for reinforcement for handling of a suspicious moving body MB. Second request information may include the position of a suspicious moving body MB.

For example, the notification unit 324 notifies a held apparatus 10 held by a security guard positioned in the surveillance area MA of second request information.

In this case, for example, the notification unit 324 determines a held apparatus 107 held by a security guard positioned in the first region and notifies the determined held apparatus 107 of second request information.

More specifically, for example, the notification unit 324 refers to first moving body information MD1 acquired within a predetermined time before reception of first request information by the first acquisition unit 104 and determines an apparatus ID including a position in the surveillance area MA.

The notification unit 324 refers to apparatus information HDI (see FIG. 21) and determines an apparatus ID associated with “security guard” out of apparatus IDs including positions in the surveillance area MA. The determined apparatus ID is information indicating a held apparatus 107 held by a security guard with a high possibility of being positioned in the surveillance area MA. The notification unit 324 notifies the determined apparatus ID of second request information.

The third example embodiment of the present invention has been described above.

The notification unit 324 according to the present example embodiment notifies a held apparatus 107 or a predetermined apparatus of notification information when second moving body information MD2 not correlated with first moving body information MD1 exists.

A user of the held apparatus 107 or the predetermined apparatus receiving the notification information can recognize that a suspicious moving body MB exists in the surveillance area MA and can handle the suspicious moving body MB. Accordingly, security in the surveillance area MA can be improved.

In general, correct correlation may not be performed due to a plurality of moving bodies MB overlapping each other in image data PD. In such a case, erroneous notification of notification information may be made in spite of nonexistence of a suspicious moving body MB in the surveillance area MA.

The notification unit 324 according to the present example embodiment makes notification of notification information when second moving body information MD2 not correlated with first moving body information MD1 exists longer than a predetermined time. Thus, the possibility of making erroneous notification of notification information can be reduced. Accordingly, user convenience of the surveillance apparatus 301 can be improved.

The notification unit 324 according to the present example embodiment makes notification of notification information when second moving body information MD2 not correlated with first moving body information MD1 stays in a predetermined area longer than a predetermined time. Thus, the possibility of making erroneous notification of notification information can be reduced. Accordingly, user convenience of the surveillance apparatus 301 can be improved.

In general, a first confidence level may be low when first moving body information MD1 exists in the shielded region SA. Even in such a case, the number of held apparatuses 107 existing in the surveillance area MA may be correctly detected by using the first moving body information MD1.

The notification unit 324 according to the present example embodiment makes notification of notification information when the number of held apparatuses 107 positioned in the surveillance area MA differs from the number of sensor moving bodies SMB positioned in the surveillance area MA and second moving body information MD2 not correlated to first moving body information MD1 exists. Thus, the possibility of making erroneous notification of notification information can be reduced. Accordingly, user convenience of the surveillance apparatus 301 can be improved.

A moving body NB according to the present example embodiment includes a security guard. The notification unit 324 notifies a held apparatus 107 held by a security guard positioned in a first region within a predetermined range from the position of a suspicious moving body MB of notification information. Thus, the security guard can recognize that a suspicious moving body MB exists in the surveillance area MA. Accordingly, security in the surveillance area MA can be improved.

When further acquiring, from a held apparatus 107 positioned in a second region within a predetermined range from the position of a suspicious moving body MB, first request information for requesting reinforcement, the notification unit 324 according to the present example embodiment notifies a held apparatus 107 other than the held apparatus 107 transmitting the first request information of second request information. The second region is a region narrower than the first region.

Thus, a moving body close to a suspicious moving body MB can request reinforcement. Accordingly, security in the surveillance area MA can be improved.

According to the present example embodiment, the risk level determination unit 325 that determines a risk level of a suspicious moving body MB is further included. Notification information includes a content based on a risk level. Thus, a moving body receiving the notification can recognize the risk level of the suspicious moving body MB and take suitable measures. Accordingly, security in the surveillance area MA can be improved.

According to the present example embodiment, a held apparatus 107 or a predetermined apparatus to which the notification unit 324 makes notification is a held apparatus 107 held by a security guard or the security apparatus 323. Thus, a security guard providing security for the surveillance area MA can be notified of notification information. Accordingly, security in the surveillance area MA can be improved.

While the example embodiments of the present invention and the modified examples thereof have been described above with reference to the drawings, the example embodiments and the modified examples are exemplifications of the present invention, and various configurations other than those described above may also be employed.

Further, while a plurality of processes (processing) are described in a sequential order in each of a plurality of flowcharts used in the aforementioned description, the execution order of processes executed in each example embodiment is not limited to the order of description. The order of the illustrated processes may be modified without affecting the contents in each example embodiment. Further, the aforementioned example embodiments and the modified examples thereof may be combined without contradicting each other.

The whole or part of the example embodiments disclosed above may also be described as, but not limited to, the following supplementary notes.
1. A surveillance apparatus including:
   a first acquisition unit that acquires first moving body information including a position of a held apparatus held by a predetermined moving body;
   a second acquisition unit that acquires second moving body information including a position and a type of a sensor moving body being a moving body detected based on sensor information generated by a sensor apparatus; and
   a correlation unit that correlates the first moving body information and the second moving body information that are related to a common moving body, based on a position of the held apparatus, and a position and a type of the sensor moving body.
2. The surveillance apparatus according to supplementary note 1, wherein
   the correlation unit correlates first moving body information and second moving body information that are related to the common moving body, further based on moving velocity acquired based on a position of the held apparatus.
3. The surveillance apparatus according to supplementary note 1 or 2, wherein
   the first moving body information includes determination information for determining a type of a moving body holding the held apparatus, and
   the correlation unit correlates first moving body information and second moving body information that are related to the common moving body, further based on the determination information.
4. The surveillance apparatus according to any one of supplementary notes 1 to 3, wherein
   the correlation unit acquires a first confidence level being a confidence level of a position included in the first moving body information, based on at least one item out of (A) reception intensity of an electromagnetic wave used for positioning of the held apparatus, (B) a positional relation between a communication apparatus that transmits or receives the electromagnetic wave and the held apparatus, (C) whether an obstacle obstructing propagation of the electromagnetic wave exists between the held apparatus and the communication apparatus, and (D) orientation of the moving body relative to the communication apparatus, and correlates first moving body information and second moving body information that are related to the common moving body, based on a position of the held apparatus where the first confidence level satisfies a first condition, and a position and a type of the sensor moving body.
5. The surveillance apparatus according to any one of supplementary notes 1 to 4, wherein
   the correlation unit acquires a first confidence level being a confidence level of a position included in the first moving body information, based on at least one item out of (A) reception intensity of an electromagnetic wave used for positioning of the held apparatus, (B) a positional relation between a communication apparatus that transmits or receives the electromagnetic wave and the held apparatus, (C) whether an obstacle obstructing propagation of the electromagnetic wave exists between the held apparatus and the communication apparatus, and (D) orientation of the moving body relative to the communication apparatus, and changes a relation between a position of a held apparatus included in a matching condition for correlating the first moving body information and the second moving body information, and a position of a sensor moving body, based on the first confidence level.
6. The surveillance apparatus according to any one of supplementary notes 1
   the correlation unit acquires a second confidence level being a confidence level of a position of the sensor moving body and correlates first moving body information and second moving body information that are related to the common moving body, based on a position of the held apparatus, a position of the sensor moving body where the second confidence level satisfies a second condition, and a type of the sensor moving body.
7. The surveillance apparatus according to any one of supplementary notes 1 to 5, wherein
   the correlation unit acquires a second confidence level being a confidence level of a position of the sensor moving body and changes a relation between a position of a held apparatus included in a matching condition for correlating the first moving body information and the second moving body information, and a position of a sensor moving body, based on the second confidence level.
8. The surveillance apparatus according to any one of supplementary notes 1 to 7, wherein
   the correlation unit corrects a position included in the first moving body information and correlates the first moving body information and the second moving body information that are related to a common moving body, based on the corrected position, and a position and a type of the sensor moving body.
9. The surveillance apparatus according to any one of supplementary notes 1 to 8, wherein
   the correlation unit corrects a position of the sensor moving body and correlates the first moving body information and the second moving body information that are related to a common moving body, based on a position of the held apparatus, the corrected position of the sensor moving body, and a type of the sensor moving body.
10. The surveillance apparatus according to any one of supplementary notes 1 to 9, wherein
   the correlation unit generates detection result information including at least one piece of information out of first information including a position of a moving body indicated by the first moving body information and the second moving body information that are correlated with each other, second information including a position of a moving body indicated by first moving body information not correlated with second moving body information, and third information including a position of a moving body indicated by second moving body information not correlated with first moving body information.
11. The surveillance apparatus according to supplementary note 10, further including
   a display control unit that causes a display unit to display a position included in the detection result information, wherein
   the display control unit causes the display unit to display a mapping diagram acquired by mapping a position included in the detection result information onto a diagram indicating a surveillance area.
12. The surveillance apparatus according to supplementary note 11, wherein
   the mapping diagram includes a shielded region being a region in which propagation of an electromagnetic wave used for positioning of the held apparatus is obstructed when viewed from a communication apparatus that transmits or receives the electromagnetic wave.
13. The surveillance apparatus according to any one of supplementary notes 1 to 12, further including
   a notification unit that notifies the held apparatus or a predetermined apparatus of notification information when the second moving body information not correlated with the first moving body information exists.
14. The surveillance apparatus according to supplementary note 13, wherein
   the notification unit makes notification of the notification information when the second moving body information not correlated with the first moving body information exists longer than a predetermined time.
15. The surveillance apparatus according to supplementary note 13 or 14, wherein
   the notification unit makes notification of the notification information when the second moving body information not correlated with the first moving body information stays in a predetermined area longer than a predetermined time.
16. The surveillance apparatus according to any one of supplementary notes 13 to 15, wherein
   the notification unit makes notification of the notification information when a number of the one or more held apparatuses positioned in the surveillance area differs from a number of one or more sensor moving bodies positioned in the surveillance area and the second moving body information not correlated with the first moving body information exists.
17. The surveillance apparatus according to any one of supplementary notes 13 to 16, wherein
   the moving body includes a security guard, and
   the notification unit notifies the held apparatus held by a security guard positioned in a first region within a predetermined range from a position of a moving body indicated by the second moving body information not correlated with the first moving body information of the notification information.
18. The surveillance apparatus according to any one of supplementary notes 13 to 17, wherein,
   when further acquiring, from the held apparatus positioned in a second region within a predetermined range from a position of a moving body indicated by the second moving body information not correlated with the first moving body information, first request information for requesting reinforcement, the notification unit notifies the held apparatus other than a held apparatus transmitting the first request information of second request information, and
   the second region is a region narrower than the first region.
19. The surveillance apparatus according to any one of supplementary notes 13 to 18, further including
   a risk level determination unit that determines a risk level of a moving body indicated by the second moving body information not correlated with the first moving body information, wherein
   the notification information includes a content based on the risk level.
20. The surveillance apparatus according to any one of supplementary notes 13 to 19, wherein
   the moving body includes a security guard, and
   the notification unit or the predetermined apparatus to which the held apparatus makes notification is a held apparatus held by a security guard or a security apparatus.
21. The surveillance apparatus according to any one of supplementary notes 1 to 20, wherein
   the sensor information includes image data or point cloud data.
22. A surveillance system including: the surveillance apparatus according to any one of supplementary notes 1 to 21; and a positioning system and a sensor apparatus that communicate with the surveillance apparatus through a network, wherein
   the positioning system includes the held apparatus and generates first moving body information including a position of the held apparatus, and the sensor apparatus generates the sensor information.
23. A surveillance method including, by a computer:
   acquiring first moving body information including a position of a held apparatus held by a predetermined moving body;
   acquiring second moving body information including a position and a type of a sensor moving body being a moving body detected based on sensor information generated by a sensor apparatus; and
   correlating the first moving body information and the second moving body information that are related to a common moving body, based on a position of the held apparatus, and a position and a type of the sensor moving body.
24. A program for causing a computer to execute:
   acquiring first moving body information including a position of a held apparatus held by a predetermined moving body;
   acquiring second moving body information including a position and a type of a sensor moving body being a moving body detected based on sensor information generated by a sensor apparatus; and
   correlating the first moving body information and the second moving body information that are related to a common moving body, based on a position of the held apparatus, and a position and a type of the sensor moving body.

### REFERENCE SIGNS LIST

100, 200, 300 Surveillance system
101, 201, 301 Surveillance apparatus
102 Positioning system
103 Sensor apparatus
104 First acquisition unit
105 Second acquisition unit
106 Correlation unit
107 Held apparatus
108 Communication apparatus
221 Display control unit
222 Display unit
323 Security apparatus
COI Authentication information
DRI Detection result information
EW Electromagnetic wave
HBI Holding body information
HDI Apparatus information
MA Surveillance area
MB Moving body
MD1 First moving body information
MD2 Second moving body information
MI Correlation information
PD Image data S
A Shielded region
SCI Suspicious moving body candidate information
SI Sensor information
SMB Sensor moving body
SOI Suspicious moving body information
SV Standard velocity data

What is claimed is:

1. A surveillance apparatus comprising:
at least one memory configured to store instructions; and
at least one processor configured to execute the instructions to perform operations comprising:
acquiring first moving body information including a position of a held apparatus held by a predetermined moving body;
acquiring second moving body information including a position and a type of a sensor moving body being a moving body detected based on sensor information generated by a sensor apparatus; and
correlating the first moving body information and the second moving body information that are related to a common moving body, based on a position of the held apparatus, and a position and a type of the sensor moving body.

2. The surveillance apparatus according to claim 1, wherein
correlating the first moving body information and the second moving body information that are related to the common moving body, further based on moving velocity acquired based on a position of the held apparatus.

3. The surveillance apparatus according to claim 1, wherein
the first moving body information includes determination information for determining a type of a moving body holding the held apparatus, and
correlating the first moving body information and the second moving body information that are related to the common moving body, further based on the determination information.

4. The surveillance apparatus according to claim 1, the instructions to perform operations further comprising
generating detection result information including at least one piece of information out of first information including a position of a moving body indicated by the first moving body information and the second moving body information that are correlated with each other, second information including a position of a moving body indicated by first moving body information not correlated with second moving body information, and third information including a position of a moving body indicated by second moving body information not correlated with first moving body information.

5. The surveillance apparatus according to claim 4, the instructions to perform operations further comprising
causing a display to display a position included in the detection result information, wherein
causing the display unit to display a mapping diagram acquired by mapping a position included in the detection result information onto a diagram indicating a surveillance area, and
the mapping diagram includes a shielded region being a region in which propagation of an electromagnetic wave used for positioning of the held apparatus is obstructed when viewed from a communication apparatus that transmits or receives the electromagnetic wave.

6. The surveillance apparatus according to claim 1, the instructions to perform operations further comprising
notifying the held apparatus or a predetermined apparatus of notification information when the second moving body information not correlated with the first moving body information exists.

7. The surveillance apparatus according to claim 6, wherein
the moving body includes a security guard,
notifying the held apparatus or a predetermined apparatus of notification information includes the held apparatus held by a security guard positioned in a first region within a predetermined range from a position of a moving body indicated by the second moving body information not correlated with the first moving body information of the notification information and when further acquiring, from the held apparatus positioned in a second region within a predetermined range from a position of a moving body indicated by the second moving body information not correlated with the first moving body information, first request information for requesting reinforcement, notifies the held apparatus other than a held apparatus transmitting the first request information of second request information, and
the second region is a region narrower than the first region.

8. The surveillance apparatus according to claim 6, the instructions to perform operations further comprising
determining a risk level of a moving body indicated by the second moving body information not correlated with the first moving body information, wherein
the notification information includes a content based on the risk level.

9. A surveillance method comprising, by a computer:
acquiring first moving body information including a position of a held apparatus held by a predetermined moving body;
acquiring second moving body information including a position and a type of a sensor moving body being a moving body detected based on sensor information generated by a sensor apparatus; and
correlating the first moving body information and the second moving body information that are related to a common moving body, based on a position of the held apparatus, and a position and a type of the sensor moving body.

10. A non-transitory computer readable storage medium storing a program for causing a computer to execute:
acquiring first moving body information including a position of a held apparatus held by a predetermined moving body;
acquiring second moving body information including a position and a type of a sensor moving body being a moving body detected based on sensor information generated by a sensor apparatus; and
correlating the first moving body information and the second moving body information that are related to a common moving body, based on a position of the held apparatus, and a position and a type of the sensor moving body.
